(19) United States
(12) Patent Application Publication
(10) Pub. No.: US 2025/0242599 A1
(43) Pub. Date: Jul. 31, 2025

(54) LIQUID EJECTION APPARATUS

(71) Applicants: Ayaka MATSUMOTO, Kanagawa (JP); Yuta MORIWAKI, Tokyo (JP)

(72) Inventors: Ayaka MATSUMOTO, Kanagawa (JP); Yuta MORIWAKI, Tokyo (JP)

(21) Appl. No.: 19/023,422

(22) Filed: Jan. 16, 2025

(30) Foreign Application Priority Data
Jan. 31, 2024 (JP) 2024-012539

(51) Int. Cl. B41J 2/175; B41J 2/165

(52) U.S. Cl. CPC B41J 2/17563; B41J 2/16508; B41J 2/17596; B41J 2002/16594

(57) ABSTRACT

A liquid ejection apparatus is provided that includes: a head tank that stores a liquid; a liquid ejection head that ejects the liquid supplied from the head tank; a liquid supply path between the head tank and the liquid ejection head; a liquid delivery device that delivers the liquid from the head tank to the liquid ejection head via the liquid supply path; a filter disposed in the liquid supply path; pressure measurement devices respectively disposed upstream and downstream of the filter; and circuitry configured to control the liquid delivery device to perform a liquid discharge operation to discharge the liquid in the head tank based on a result calculated from measurement values of the pressure measurement devices.

### CROSS-REFERENCE TO RELATED APPLICATIONS

This patent application is based on and claims priority pursuant to 35 U.S.C. § 119(a) to Japanese Patent Application No. 2024-012539, filed on Jan. 31, 2024, in the Japan Patent Office, the entire disclosure of which is hereby incorporated by reference herein.

### BACKGROUND

### Technical Field

The present disclosure relates to a liquid ejection apparatus.

### Related Art

A conventional liquid ejection apparatus (e.g., inkjet apparatus) includes, in a supply path for supplying ink to an inkjet head, a filter for filtering the ink, pressure sensors disposed upstream and downstream of the filter.

### SUMMARY

Embodiments of the present invention provide a liquid ejection apparatus that includes: a head tank that stores a liquid; a liquid ejection head that ejects the liquid supplied from the head tank; a liquid supply path between the head tank and the liquid ejection head; a liquid delivery device that delivers the liquid from the head tank to the liquid ejection head via the liquid supply path; a filter disposed in the liquid supply path; pressure measurement devices respectively disposed upstream and downstream of the filter; and circuitry configured to control the liquid delivery device to perform a liquid discharge operation to discharge the liquid in the head tank based on a result calculated from measurement values of the pressure measurement devices.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic plan view of a liquid ejection apparatus according to an embodiment of the present invention;

FIG. 2 is a schematic plan view of a liquid ejection apparatus according to an embodiment of the present invention;

FIG. 3 is a flowchart of a process performed by a controller according to an embodiment of the present invention,

FIG. 4 is a flowchart of a process performed by a controller according to an embodiment of the present invention;

FIG. 5A is a schematic plan view of a mechanism part of an image forming apparatus according to an embodiment of the present invention;

FIG. 5B is a schematic side view of a mechanism part of an image forming apparatus according to an embodiment of the present invention;

FIG. 5C is a schematic plan view of an inkjet head of an image forming apparatus according to an embodiment of the present invention;

FIG. 6 is a diagram illustrating a hardware configuration of an image forming apparatus according to an embodiment of the present invention;

FIGS. 7A-1 and 7A-2 are a flowchart and a block diagram, respectively, relating to an image formation function of an image forming apparatus according to an embodiment of the present invention;

FIGS. 7B-1 and 7B-2 are a flowchart and a block diagram, respectively, relating to a maintenance function of an image forming apparatus according to an embodiment of the present invention;

FIG. 8 is a schematic plan view of a three-dimensional fabricating apparatus according to an embodiment of the present invention;

FIG. 9 is a schematic cross-sectional view of the three-dimensional fabricating apparatus in FIG. 8 as viewed from the right in FIG. 8;

FIG. 10 is a schematic cross-sectional view of a powder holder in FIG. 9;

FIG. 11 is a perspective explanatory view of a main part of a three-dimensional fabricating apparatus according to an embodiment of the present invention;

FIG. 12 is a block diagram illustrating an outline of a controller in a three-dimensional fabricating apparatus; and

FIGS. 13A to 13F are explanatory diagrams for describing a powder layer forming operation according to an embodiment of the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a liquid ejection apparatus having a filter recovering function is provided.

Pigment ink used in a conventional liquid ejection apparatus (e.g., inkjet apparatus) may contain a solvent and an inorganic pigment, and since there is a large difference in density between the solvent and the inorganic pigment, it is difficult to maintain a stable dispersion state for a long period of time. As a result, for example, in a location where the ink accumulates, such as in a head tank or a filter unit, a pigment component included in the ink may sediment or aggregate, increasing a fluid resistance value, which may result in problems such as filter clogging and nozzle omission. Further, similar problems have occurred not only with the pigment ink, but also with ink with a high solid content or high viscosity used in a 3D printer or the like due to the sedimentation or aggregation of the solid content.

A conventional printing apparatus determines and notifies filter deterioration (filter clogging) based on the pressure difference measured by pressure sensors respectively provided upstream and downstream of the filter, and prompts a user to replace the filter, thereby resolving the above-mentioned problems. However, such a printing apparatus does not have a means for recovering a function of the filter after determining the filter deterioration, making it necessary to replace the filter.

A liquid ejection apparatus according to an embodiment of the present invention fully resolves various concerns. More details are as follows. The liquid ejection apparatus according to an embodiment of the present invention controls a liquid discharge operation for discharging a liquid from a head tank based on a result calculated from measurement values of pressure measurement devices respectively provided upstream and downstream of a filter. With this configuration, a foreign matter that causes clogging of the filter is removed, and the liquid in the head tank is replaced, thereby making it possible to recover the function of the filter.

Embodiments of the present invention is described in detail below.

### (Liquid Ejection Apparatus)

The liquid ejection apparatus according to an embodiment of the present invention includes a head tank that stores a liquid, a liquid ejection head that ejects the liquid supplied from the head tank, a liquid supply path between the head tank and the liquid ejection head, a liquid delivery device that delivers the liquid from the head tank to the liquid ejection head via the liquid supply path, a filter disposed in the liquid supply path, pressure measurement devices respectively disposed upstream and downstream of the filter, and circuitry configured to control the liquid delivery device to perform a liquid discharge operation to discharge the liquid in the head tank based on a result calculated from measurement values of the pressure measurement devices, and may also include a cleaning device that cleans the liquid ejection head and other devices as necessary.

A printing apparatus according to embodiments of the present invention is described below with reference to the drawings. However, the present invention is not limited to these embodiments.

Note that, in each drawing, the same components are given the same reference numerals, and duplicated explanation thereof may be omitted. Further, the numbers, positions, shapes, and the like of the following constituent members are not limited to those of the present embodiments, and may be any numbers, positions, shapes, and the like that are preferable for implementing the present invention.

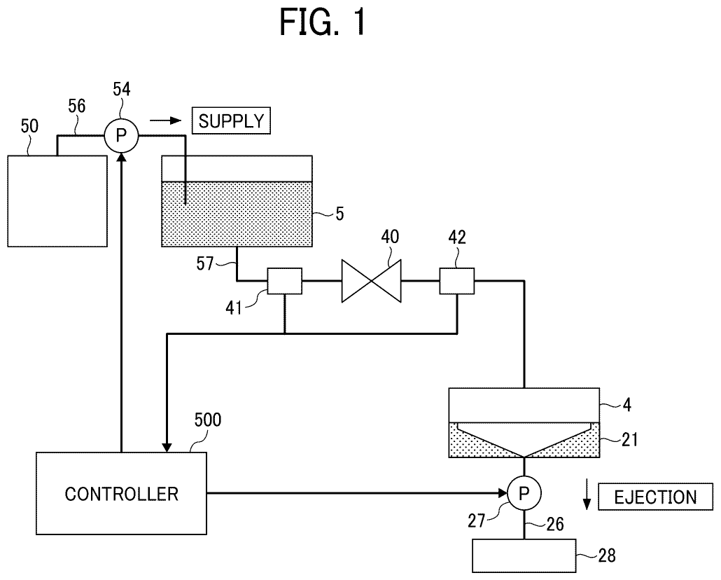

FIG. 1 is a schematic plan view of a liquid ejection apparatus according to an embodiment of the present invention.

A liquid ejection apparatus 1000 includes a head tank 5 as the head tank, a recording head 4 as the liquid ejection head, a liquid delivery pump 54 as the liquid delivery device, a filter 40 as the filter, an upstream pressure sensor 41 and a downstream pressure sensor 42 as the pressure measurement devices, and a controller 500 as the circuitry, and also includes a suction cap 21, a suction pump 27, a waste liquid tank 28, and a main tank 50 as other units.

In the liquid ejection apparatus 1000, a liquid is supplied from the main tank 50 to the head tank 5 via a supply tube 56 by the liquid delivery pump 54, and is temporarily stored in the head tank 5. Similarly, the liquid is supplied from the head tank 5 to the recording head 4 via a liquid supply path 57 by the liquid delivery pump 54. The drive control of the liquid delivery pump 54 is performed by the controller 500.

The filter 40 that filters the liquid is provided in the liquid supply path 57 from the head tank 5 to the recording head 4, and the upstream pressure sensor 41 is provided upstream of the filter 40, and the downstream pressure sensor 42 is provided downstream of the filter 40. The drive control of these pressure sensors is performed by the controller 500.

The recording head 4 includes the suction cap 21 that caps a nozzle surface, and the suction pump 27 connected to the suction cap 21.

When the suction pump 27 is driven with the nozzle surface capped by the suction cap 21, the liquid in the head tank 5 and the recording head 4 is sucked through a nozzle and a suction tube 26. The sucked liquid is discharged into the waste liquid tank 28. The drive control of this suction pump 27 is performed by the controller 500.

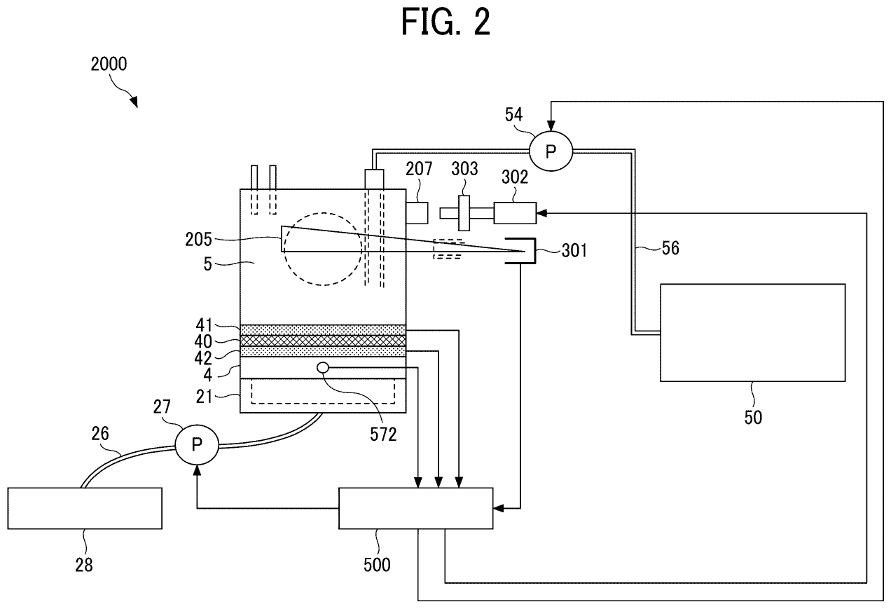

FIG. 2 is a schematic plan view of a liquid ejection apparatus according to an embodiment of the present invention.

In addition to the structure of the liquid ejection apparatus 1000 illustrated in FIG. 1, a liquid ejection apparatus 2000 includes a displacement member 205, an atmosphere opening mechanism 207, a filler sensor 301, an atmosphere opening solenoid 302, an operating member 303, and a temperature sensor 572.

The displacement member 205 is a member that is displaced according to the remaining amount of the liquid in the head tank 5. The displacement member 205 is detected and positioned by the filler sensor 301. Based on the detection result of the filler sensor 301, a recovery operation described below can be controlled (e.g., the delivery of the liquid can be controlled while the head tank 5 is open to the atmosphere).

Note that, when the inside of the head tank 5 is subjected to negative pressure control by the upstream pressure sensor 41 and the downstream pressure sensor 42, the filler sensor 301 does not need to be provided.

Inside the head tank 5, the openable atmosphere opening mechanism 207 is provided that opens the inside of the head tank 5 to the atmosphere. On the other hand, the operating member 303 that performs an opening operation of the atmosphere opening mechanism 207 and the atmosphere opening solenoid 302 that moves the operating member 303 are provided outside the head tank 5. By operating this atmosphere opening solenoid 302, the inside of the head tank 5 can be opened to the atmosphere via the atmosphere opening mechanism 207. The drive control of this atmosphere opening solenoid 302 is performed by the controller 500.

The recording head 4 includes a temperature sensor 572 as a temperature detection device that detects a temperature (head temperature) of the recording head 4.

### <Liquid Delivery Device>

The liquid delivery device is not particularly limited and can be appropriately selected depending on the purpose. However, the liquid delivery device is preferably a reversible pump (reversible liquid delivery device) such as a tube pump.

The reversible pump described herein is a pump that can perform both a liquid delivery operation of delivering the liquid from the main tank 50 to the head tank 5 and a reverse delivery operation of delivering the liquid from the head tank 5 to the main tank 50.

### <Filter>

The filter is preferably provided in a filter chamber. The structure of the filter chamber is not particularly limited and can be appropriately selected depending on the purpose. However, the filter chamber preferably has a structure that can easily eject an air bubble. Examples of the structure that can easily eject an air bubble include the structure described in JP-A-2008-030333.

The shape of the filter is not particularly limited and can be appropriately selected from known filters. From the viewpoint of obtaining excellent long-term ejection stability, the filter is preferably a filter in which a large number of uniform holes are made in a stainless steel or polyimide plate by a punch, laser, or the like, a sintered filter in which stainless steel fibers are layered in a felt-like form and sintered, and a twilled dutch weave filter in which stainless steel fibers are woven in a twilled dutch weave form.

A material of the filter is not particularly limited and can be appropriately selected depending on the purpose. However, from the viewpoint of obtaining corrosion resistance, the material is preferably made of stainless steel or polyimide.

Of these, as the material of the filter, austenitic stainless steel is preferable because of its excellent corrosion resistance, and SUS304, SUS316, and SUS316L are more preferable.

These may be used alone or in combination of two or more.

The average pore size of the filter is not particularly limited and can be appropriately selected depending on the physical properties of the liquid to be used and the like. However, the average pore size is preferably 5 μm or more and 20 μm or less from the viewpoint of obtaining good ejection stability and liquid permeability.

The average thickness of the filter is not particularly limited and can be appropriately selected depending on the purpose. However, the average thickness is preferably 0.1 mm or more and 0.5 mm or less because this achieves good ejection stability and liquid permeability.

### <Pressure Measurement Device>

The pressure measurement devices measure a pressure inside the liquid supply path, and are respectively provided upstream and downstream of the filter.

The pressure measurement devices are not particularly limited as long as the pressure can be finally measured and/or calculated, and can be appropriately selected depending on the purpose. Examples of the pressure measurement device include a pressure sensor and a flow rate sensor.

The pressure sensor may be provided inside the liquid supply path or at a different location by creating a branch from the liquid supply path. The pressure sensor may be provided upstream of the head tank 5 but downstream of the liquid delivery pump 54.

In the liquid ejection apparatus according to an embodiment of the present invention, the pressure may be calculated from the flow rate of the liquid. In such a case of calculating the flow rate of the liquid, a flow rate sensor is provided inside the liquid supply path.

A method for calculating the pressure inside the liquid supply path is not particularly limited and can be appropriately selected depending on the purpose. For example, since the diameter of the liquid supply path is constant from upstream to downstream, the pressure can be calculated from the relationship between the pressure and the flow rate (the pressure is proportional to the square of the flow rate). Note that the flow rate sensor may be provided separately from the pressure measurement devices.

### <Controller>

The controller is a device that controls a liquid discharge operation of the liquid delivery device to discharge the liquid in the head tank based on a result calculated from measurement values of the pressure measurement devices.

The controller preferably controls the liquid discharge operation of the liquid delivery device to discharge the liquid in the head tank based on a fluid resistance value or a pressure loss value calculated from the measurement values of the pressure measurement devices.

The fluid resistance value and the pressure loss value described herein indicate a deterioration (clogging) state of the filter.

Examples of a method for calculating the pressure loss value include a method of using the difference between a pressure measured and/or calculated by the pressure measurement device provided upstream of the filter and a pressure measured and/or calculated by the pressure measurement device provided downstream of the filter.

Examples of a method for calculating the fluid resistance value include a method of using an equation:

fluid resistance value=pressure value/flow rate

based on the following relational equation.

voltage=current×resistance

More specific examples thereof include a method of dividing the difference between a pressure value measured by the pressure measurement device provided upstream of the filter and a pressure value measured by the pressure measurement device provided downstream of the filter by a flow rate value measured by the pressure measurement devices.

In a case where a flow rate sensor is provided separately from the pressure measurement devices, examples of the method of determining the fluid resistance value includes a method of dividing the difference between a pressure value measured by the pressure measurement device provided upstream of the filter and a pressure value measured by the pressure measurement device provided downstream of the filter by a flow rate value measured by the flow rate sensor.

It is preferable that the calculation of the fluid resistance value and the pressure loss value is performed at the same time as regular maintenance of the liquid ejection apparatus.

The term “regular maintenance” described herein refers to a cleaning operation performed by the cleaning device at regular intervals (e.g., once every several hours) that are set in advance. The cleaning operation is not particularly limited as long as the cleaning operation is performed on the head tank and the liquid ejection head, and can be appropriately selected according to the purpose. However, the cleaning operation is preferably a series of operations including sucking and discharging the liquid in the head tank, wiping the nozzle surface of the liquid ejection head, and then performing a blank ejection operation.

Note that the regular maintenance may be performed manually.

The timing for calculating the fluid resistance value and the pressure loss value is not particularly limited and can be appropriately selected depending on the purpose. However, the timing is preferably any of the following (1) to (4), more preferably either one of the following (1) and (2).

(1) At the time when a liquid suction operation is performed by the suction pump during the regular maintenance.

(2) At the time when a blank ejection operation is performed during the regular maintenance.

(3) At the time when a liquid suction operation is performed by the suction pump at a different time from the regular maintenance.

(4) At the time when a liquid supply operation is performed by a supply pump at a different time from the regular maintenance.

Note that, in the liquid suction operation (3) and the liquid supply operation (4), the amount of the liquid used is preferably about 0.2 mL. Further, the liquid supply operation (4) is an operation in which the liquid is continuously supplied into the head tank by the supply pump, thereby pressurizing and ejecting the liquid.

### <<Liquid Discharge Operation>>

The liquid discharge operation is controlled by the controller based on the fluid resistance value or the pressure loss value calculated from the measurement values of the pressure measurement devices.

### [Controller]

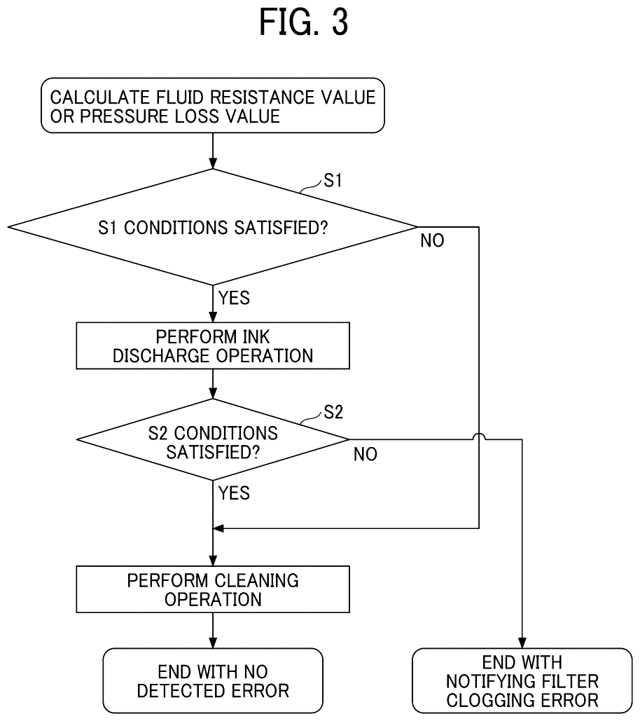

A controller according to an embodiment of the present invention is described with reference to a flow chart in FIG. 3.

When the calculated fluid resistance value or pressure loss value meet any of the following conditions S1, the liquid discharge operation is performed (see S1 in FIG. 3, direction of YES).

### Conditions S1:

a case where the fluid resistance value exceeds a threshold value r; or
a case where the fluid resistance value or the pressure loss value exceeds 110% of its initial value.

Under these conditions, the total amount of the discharged liquid during the regular maintenance can be reduced, which is preferable.

Note that, if the calculated fluid resistance value or pressure loss value do not meet any of the conditions S1, it is preferable to perform the cleaning operation without performing the liquid discharge operation (see S1 in FIG. 3, direction of NO).

The “threshold value r” of the fluid resistance value is a specific value that differs depending on the type of liquid used. The threshold value r of the liquid can be set, for example, to the maximum fluid resistance value at which the fluid resistance value of the liquid can be recovered to its initial value by the recovery operation of the actual apparatus and the actual liquid.

In the present disclosure, the liquid and the liquid ejection apparatus in which the threshold value r of the liquid is registered in advance are used together, so that the total amount of the discharged liquid during the regular maintenance can be preferably reduced.

Further, the “initial value” of the fluid resistance value and the pressure loss value is a value measured and/or calculated during the suction operation at the time of initial filling of the liquid.

If the calculated fluid resistance value or pressure loss value do not meet any of the conditions S1 described above, it is preferable to continue the cleaning operation. This cleaning operation is similar to that in the regular maintenance, and thus a description thereof is omitted.

The liquid discharge operation is not particularly limited as long as it is an operation in which the liquid in the head tank is discharged to the outside of the head tank, and can be appropriately selected depending on the purpose. However, the liquid discharge operation is preferably any of the following (5) to (8).

(5) The liquid suction operation performed by the suction pump.

(6) The liquid supply operation performed by the supply pump.

(7) The liquid suction operation performed by the suction pump and the liquid supply operation performed by the supply pump.

(8) The operation of ejecting the liquid from the liquid ejection head.

Here, the liquid supply operation (6) is an operation in which the liquid is continuously supplied into the head tank by the supply pump, thereby pressurizing and ejecting the liquid.

The liquid discharge operation is preferably the operation (7), in which the liquid suction operation and the liquid supply operation are performed simultaneously. from the viewpoint of increasing the pressure difference and further improving the filter function, and from the viewpoint of only needing to perform wiping once after the liquid discharge operation.

The liquid suction operation (5) is preferable because the wiping after the liquid discharge operation needs to be performed only once. The ejection operation (8) is preferable because the wiping after the liquid discharge operation is not required.

The liquid discharge operation is preferably an operation for discharging the ink in the head tank and near the filter. A method for discharging the liquid near the filter is not particularly limited and can be appropriately selected depending on the purpose. However, for example, such a method can be performed by providing the suction pump near the filter, by providing the filter in the head tank at a position near the liquid ejection head, or the like.

The amount of the liquid discharged by the one time of the liquid discharge operation is not particularly limited and can be appropriately selected depending on the purpose. From the viewpoint of obtaining good liquid permeability, the amount of the discharged liquid is preferably 5 times or more the amount of the liquid used in the cleaning operation and 2.5 times or less the capacity of the head tank. Note that “5 times the amount of the liquid used in the cleaning operation” is, for example, 1 mL, and “2.5 times the capacity of the head tank” is, for example, 10 mL.

In other words, the amount of the liquid discharged by the one time of the liquid discharge operation is preferably 1 mL or more and 10 mL or less.

If the liquid discharge operation includes only the liquid suction operation by the suction pump, it is preferable to stop the liquid suction operation when half the capacity of the head tank is sucked, and to resume the liquid suction operation after performing the liquid supply operation. This is to prevent damage to the head tank and a backflow of air due to negative pressure.

During the liquid discharge operation, it is preferable to continue calculating the fluid resistance value or the pressure loss value at specific intervals (e.g., at every cleaning operation).

During the liquid discharge operation, it is preferable to terminate the liquid discharge operation when the calculated fluid resistance value or pressure loss value meet any of the following conditions S2 (see S2 in FIG. 3).

### Conditions S2:

a case where the fluid resistance value falls below the threshold value r;
a case where the fluid resistance value or the pressure loss value becomes less than 110% of its initial value; or
a case where the amount of the discharged liquid becomes 2.5 times the capacity of the head tank.

When the liquid discharge operation is terminated at the time when the fluid resistance value falls below the threshold value r, or at the time when the fluid resistance value or the pressure loss value becomes less than 110% of the initial value, it is preferable to continue the cleaning operation (see S2 in FIG. 3, direction of YES).

When the liquid discharge operation is terminated at the time when the amount of the discharged liquid becomes 2.5 times the capacity of the head tank (e.g., 10 mL), it is preferable to display a message such as “Filter clogging error” to the user and prompt the user to replace the filter (see S2 in FIG. 3, direction of NO).

Note that, if the fluid resistance value and the pressure loss value calculated during the liquid discharge operation each tend to decrease as the liquid is discharged and become close to the threshold value r or 110% of the initial value, a strong cleaning operation such as refreshing may be performed. By performing such a strong cleaning operation such as refreshing, the fluid resistance value and the pressure loss value may each fall within an allowable range.

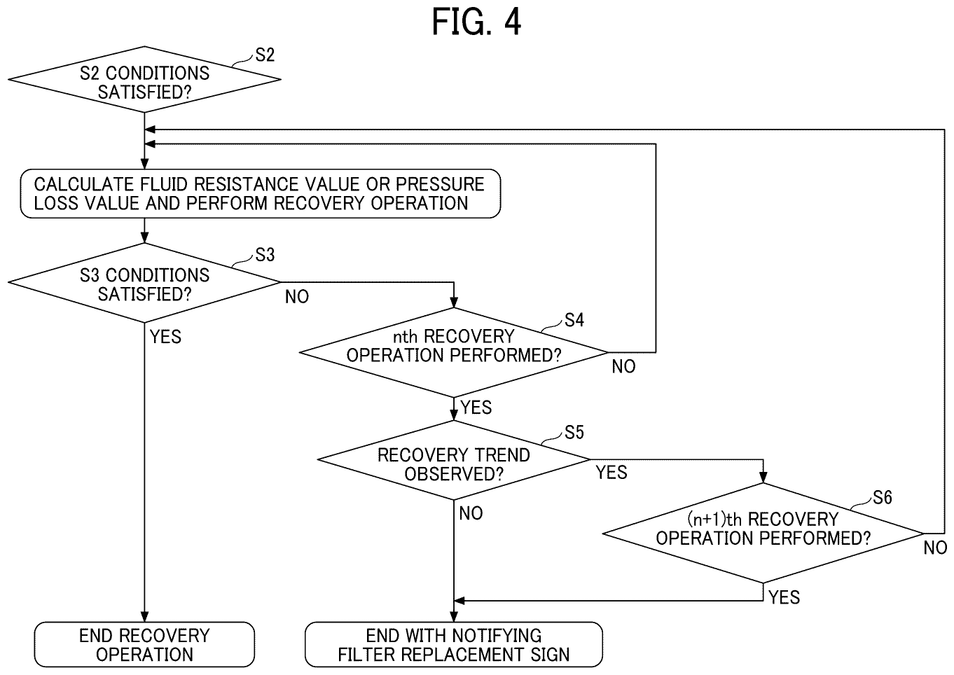

Another example of a controller according to an embodiment of the present invention is described with reference to a flow chart in FIG. 4.

FIG. 4 is a flowchart for describing another example of the controller according to an embodiment of the present invention. Further, FIG. 4 is a derived flowchart derived from S2 in FIG. 3 in the direction of NO.

The controller preferably includes a recovery controller that controls a recovery operation for recovering the filter from clogging by operating the liquid delivery device based on the fluid resistance value or the pressure loss value calculated from the measurement values of the pressure measurement devices.

In other words, if the fluid resistance value and the pressure loss value calculated after the liquid discharge operation do not meet the conditions S2, it is preferable to operate the liquid delivery device and perform the recovery operation for recovering the filter from clogging. The recovery operation is preferably the same as the liquid supply operation (6) by the supply pump.

The recovery operation is preferably performed repeatedly from the viewpoint of further improving the fluid resistance value and the pressure loss value.

During the recovery operation, it is preferable to continue calculating the fluid resistance value and/or the pressure loss value at specific intervals (e.g., at every cleaning operation).

During the recovery operation, it is preferable to end the recovery operation when the calculated fluid resistance value and pressure loss value meet any of the following conditions S3 (see S3 in FIG. 4).

### Conditions S3:

a case where the fluid resistance value falls below the threshold value r;
a case where the fluid resistance value or the pressure loss value becomes less than 110% of its initial value; or
a case where the amount of the discharged liquid becomes 2.5 times the capacity of the head tank.

When the recovery operation is terminated at the time when the fluid resistance value falls below the threshold value r, or at the time when the fluid resistance value or the pressure loss value becomes less than 110% of its initial value, it is preferable to end the recovery operation and continue the cleaning operation (see S3 in FIG. 4, direction of YES).

When the liquid discharge operation is terminated at the time when the amount of the discharged liquid becomes 2.5 times the capacity of the head tank (e.g., 10 mL), it is preferable to repeat the recovery operation (see S3 in FIG. 4, direction of NO).

Here, when the number of repetitions of the recovery operation is defined by n, the controller preferably determines whether or not to perform the (n+1)ₜₕ recovery operation based on the fluid resistance value or the pressure loss value calculated after the nₜₕ recovery operation (see S4 to S6 in FIG. 4). In a similar manner, the controller may determine whether or not to perform the (n+2)ₜₕ recovery operation.

The repetition number n is not particularly limited and can be appropriately selected depending on the purpose.

Further, the controller preferably performs the (n+1)ₜₕ recovery operation when recovery trend is observed in the fluid resistance value or the pressure loss value calculated after the nₜₕ recovery operation (see S5 in FIG. 4, direction of YES). In other words, when no recovery trend is observed in the fluid resistance value or the pressure loss value calculated after the nₜₕ recovery operation, it is preferable that the controller does not perform the (n+1)ₜₕ recovery operation (see S5 in FIG. 4, direction of NO). In that case, it is preferable to display a message such as “Filter clogging error” to the user and prompt the user to replace the filter.

Under such conditions, the liquid can be prevented from being discharged in an amount more than necessary during the recovery operation, which is preferable.

Further, the controller preferably ends the recovery operation when the repetition number of the recovery operation reaches a predetermined number.

The “predetermined number” described herein is not particularly limited and can be set appropriately depending on the repetition number n. For example, setting the predetermined number is effective when some recovery trend is observed in the fluid resistance value or the pressure loss value calculated after the recovery operation, but the degree of recovery is small, and is preferable as the liquid can be prevented from being discharged in an amount more than necessary during the recovery operation.

### <Liquid>

The liquid is not particularly limited and can be appropriately selected depending on the purpose. Examples of the liquid include ink.

The ink is not particularly limited and can be appropriately selected depending on the purpose. For example, the ink may include an organic solvent, a coloring material, a resin, and water, and may include other components as necessary.

From the viewpoint of easily obtaining the effects of the recovery operation, it is preferable that the ink applied to the liquid ejection apparatus according to an embodiment of the present invention contains solid contents of the coloring material and the resin in an amount of 15% by mass or more of the ink in total. In other words, solid contents of the coloring material and the resin account for 15% by mass or more of the ink.

### —Organic Solvent—

The organic solvent is not particularly limited and can be appropriately selected depending on the purpose. For example, a water-soluble organic solvent can be used. Examples of the water-soluble organic solvent include a polyhydric alcohol, an ether such as a polyhydric alcohol alkyl ether or a polyhydric alcohol aryl ether, a nitrogen-containing heterocyclic compound, an amide, an amine, and a sulfur-containing compound.

Specific examples of the water-soluble organic solvent include: a polyhydric alcohol such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, or 3-methyl-1,3,5-pentanetriol; a polyhydric alcohol alkyl ether such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, or propylene glycol monoethyl ether; a polyhydric alcohol aryl ether such as ethylene glycol monophenyl ether or ethylene glycol monobenzyl ether; a nitrogen-containing heterocyclic compound such as 2-pyrrolidone, N-methyl-2-pyrrolidone, N-hydroxyethyl-2-pyrrolidone, 1,3-dimethyl-2-imidazolidinone, ε-caprolactam, or γ-butyrolactone; an amide such as formamide, N-methylformamide, N,N-dimethylformamide, 3-methoxy-N,N-dimethylpropionamide, or 3-butoxy-N,N-dimethylpropionamide; an amine such as monoethanolamine, diethanolamine, or triethylamine; a sulfur-containing compound such as dimethyl sulfoxide, sulfolane, or thiodiethanol; propylene carbonate; and ethylene carbonate.

Of these, it is preferable to use the organic solvent having a boiling point of 250° C. or lower because such an organic solvent not only functions as a wetting agent but also provides good drying properties.

As the organic solvent, a polyol compound having 8 or more carbon atoms and a glycol ether compound are also preferably used.

Specific examples of the polyol compound having 8 or more carbon atoms include 2-ethyl-1,3-hexanediol and 2,2,4-trimethyl-1,3-pentanediol.

Specific examples of the glycol ether compound include: a polyhydric alcohol alkyl ether such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, or propylene glycol monoethyl ether; and a polyhydric alcohol aryl ether such as ethylene glycol monophenyl ether or ethylene glycol monobenzyl ether.

The polyol compound having 8 or more carbon atoms and the glycol ether compound can improve the permeability of the ink when a paper is used as the recording medium.

The content of the organic solvent is not particularly limited and can be appropriately selected depending on the purpose. However, from the viewpoint of drying properties and ejection reliability of the ink, the content of the organic solvent is preferably 10% by mass or more and 60% by mass or less, more preferably 20% by mass or more and 60% by mass or less, relative to the total amount of the ink.

### —Water—

The content of the water is not particularly limited and can be appropriately selected depending on the purpose. However, from the viewpoint of drying properties and ejection reliability of the ink, the content of the water is preferably 10% by mass or more and 90% by mass or less, more preferably 20% by mass or more and 60% by mass or less, relative to the total amount of the ink.

### —Coloring Material—

The coloring material is not particularly limited and can be appropriately selected depending on the purpose, and a pigment and a dye can be used.

As the pigment, an inorganic pigment or an organic pigment can be used. These may be used alone or in combination of two or more. Further, mixed crystals may also be used.

Examples of the pigment that can be used include a black pigment, a yellow pigment, a magenta pigment, a cyan pigment, a white pigment, a green pigment, an orange pigment, a glossy pigment such as a gold or silver pigment, and a metallic pigment.

Examples of the inorganic pigment that can be used include titanium oxide, iron oxide, calcium carbonate, barium sulfate, aluminum hydroxide, barium yellow, cadmium red, and chrome yellow, as well as carbon black produced by a known method such as the contact method, the furnace method, or the thermal method.

Examples of the organic pigment that can be used include an azo pigment, a polycyclic pigment (e.g., a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinophthalone pigment, etc.), a dye chelate (e.g., a basic dye chelate, an acidic dye chelate, etc.), a nitro pigment, a nitroso pigment, and aniline black. Of these pigments, those having good affinity with the solvent are preferably used. In addition, a resin hollow particle and an inorganic hollow particle can also be used.

Specific examples of the black pigment include: a carbon black (C.I. Pigment Black 7) such as furnace black, lamp black, acetylene black, or channel black; a metal such as copper, iron (C.I. Pigment Black 11), or titanium oxide; and an organic pigment such as aniline black (C.I. Pigment Black 1).

Specific examples of the color pigment include C.I. Pigment Yellow 1, C.I. Pigment Yellow 3, C.I. Pigment Yellow 12, C.I. Pigment Yellow 13, C.I. Pigment Yellow 14, C.I. Pigment Yellow 17, C.I. Pigment Yellow 24, C.I. Pigment Yellow 34, C.I. Pigment Yellow 35, C.I. Pigment Yellow 37, C.I. Pigment Yellow 42 (Yellow Iron Oxide), C.I. Pigment Yellow 53, C.I. Pigment Yellow 55, C.I. Pigment Yellow 74, C.I. Pigment Yellow 81, C.I. Pigment Yellow 83, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 108, C.I. Pigment Yellow 109, C.I. Pigment Yellow 110, C.I. Pigment Yellow 117, C.I. Pigment Yellow 120, C.I. Pigment Yellow 138, C.I. Pigment Yellow 150, C.I. Pigment Yellow 153, C.I. Pigment Yellow 155, C.I. Pigment Yellow 180, C.I. Pigment Yellow 185, C.I. Pigment Yellow 213, C.I. Pigment Orange 5, C.I. Pigment Orange 13, C.I. Pigment Orange 16, C.I. Pigment Orange 17, C.I. Pigment Orange 36, C.I. Pigment Orange 43, C.I. Pigment Orange 51, C.I. Pigment Red 1, C.I. Pigment Red 2, C.I. Pigment Red 3, C.I. Pigment Red 5, C.I. Pigment Red 17, C.I. Pigment Red 22, C.I. Pigment Red 23, C.I. Pigment Red 31, C.I. Pigment Red 38, C.I. Pigment Red 48:2, C.I. Pigment Red 48:2 (Permanent Red 2B (Ca)), C.I. Pigment Red 48:3, C.I. Pigment Red 48:4, C.I. Pigment Red 49:1, Pigment Red 52:2, C.I. Pigment Red 53:1, C.I. Pigment Red 57:1 (Brilliant Carmine 6B), C.I. Pigment Red 60:1, C.I. Pigment Red 63:1, C.I. Pigment Red 63:2, C.I. Pigment Red 64:1, C.I. Pigment Red 81, C.I. Pigment Red 83, C.I. Pigment Red 88, C.I. Pigment Red 101 (Iron Oxide), C.I. Pigment Red 104, C.I. Pigment Red 105, C.I. Pigment Red 106, C.I. Pigment Red 108 (Cadmium Red), C.I. Pigment Red 112, C.I. Pigment Red 114, C.I. Pigment Red 122 (Quinacridone Magenta), C.I. Pigment Red 123, C.I. Pigment Red 146, C.I. Pigment Red 149, C.I. Pigment Red 166, C.I. Pigment Red 168, C.I. Pigment Red 170, C.I. Pigment Red 172, C.I. Pigment Red 177, C.I. Pigment Red 178, C.I. Pigment Red 179, C.I. Pigment Red 184, C.I. Pigment Red 185, C.I. Pigment Red 190, C.I. Pigment Red 193, C.I. Pigment Red 202, C.I. Pigment Red 207, C.I. Pigment Red 208, C.I. Pigment Red 209, C.I. Pigment Red 213, C.I. Pigment Red 219, C.I. Pigment Red 224, C.I. Pigment Red 254, C.I. Pigment Red 264, C.I. Pigment Violet 1 (Rhodamine Lake), C.I. Pigment Violet 3, C.I. Pigment Violet 5:1, C.I. Pigment Violet 16, C.I. Pigment Violet 19, C.I. Pigment Violet 23, C.I. Pigment Violet 38, C.I. Pigment Blue 1, C.I. Pigment Blue 2, C.I. Pigment Blue 15 (Phthalocyanine Blue), C.I. Pigment Blue 15:1, C.I. Pigment Blue 15:2, C.I. Pigment Blue 15:3, C.I. Pigment Blue 15:4 (Phthalocyanine Blue), C.I. Pigment Blue 16, C.I. Pigment Blue 17:1, C.I. Pigment Blue 56, C.I. Pigment Blue 60, C.I. Pigment Blue 63, C.I. Pigment Green 1, C.I. Pigment Green 4, C.I. Pigment Green 7, C.I. Pigment Green 8, C.I. Pigment Green 10, C.I. Pigment Green 17, C.I. Pigment Green 18, and C.I. Pigment Green 36.

The dye is not particularly limited, and an acid dye, a direct dye, a reactive dye, and a basic dye can be used. These dyes may be used alone or in combination of two or more.

Specific examples of the dye include C.I. Acid Yellow 17, C.I. Acid Yellow 23, C.I. Acid Yellow 42, C.I. Acid Yellow 44, C.I. Acid Yellow 79, C.I. Acid Yellow 142, C.I. Acid Red 52, C.I. Acid Red 80, C.I. Acid Red 82, C.I. Acid Red 249, C.I. Acid Red 254, C.I. Acid Red 289, C.I. Acid Blue 9, C.I. Acid Blue 45, C.I. Acid Blue 249, C.I. Acid Black 1, C.I. Acid Black 2, C.I. Acid Black 24, C.I. Acid Black 94, C.I. Food Black 1, C.I. Food Black 2, C.I. Direct Yellow 1, C.I. Direct Yellow 12, C.I. Direct Yellow 24, C.I. Direct Yellow 33, C.I. Direct Yellow 50, C.I. Direct Yellow 55, C.I. Direct Yellow 58, C.I. Direct Yellow 86, C.I. Direct Yellow 132, C.I. Direct Yellow 142, C.I. Direct Yellow 144, C.I. Direct Yellow 173, C.I. Direct Red 1, C.I. Direct Red 4, C.I. Direct Red 9, C.I. Direct Red 80, C.I. Direct Red 81, C.I. Direct Red 225, C.I. Direct Red 227, C.I. Direct Blue 1, C.I. Direct Blue 2, C.I. Direct Blue 15, C.I. Direct Blue 71, C. C.I. Direct Blue 86, C.I. Direct Blue 87, C.I. Direct Blue 98, C.I. Direct Blue 165, C.I. Direct Blue 199, C.I. Direct Blue 202, C.I. Direct Black 19, C.I. Direct Black 38, C.I. Direct Black 51, C.I. Direct Black 71, C.I. Direct Black 154, C.I. Direct Black 168, C.I. Direct Black 171, C.I. Direct Black 195, C.I. Reactive Red 14, C.I. Reactive Red 32, C.I. Reactive Red 55, C.I. Reactive Red 79, C.I. Reactive Red 249, C.I. Reactive Black 3, C.I. Reactive Black 4, and C.I. Reactive Black 35.

The content of the coloring material is preferably 0.1% by mass or more and 15% by mass or less, more preferably 1% by mass or more and 10% by mass or less, relative to the total amount of the ink, from the viewpoints of improving image density, good fixability, and ejection stability.

Examples of a method of dispersing the pigment to obtain the ink include a method of introducing a hydrophilic functional group to the pigment to make it a self-dispersing pigment, a method of dispersing the pigment by coating the surface of the pigment with a resin, and a method of dispersing the pigment by using a dispersant.

Examples of the method of introducing a hydrophilic functional group to the pigment to make it a self-dispersing pigment include a method of making the pigment dispersible in water by adding a functional group such as a sulfone group or a carboxyl group to the pigment (e.g., carbon).

Examples of the method of dispersing the pigment by coating the surface of the pigment with a resin include a method of making the pigment dispersible in water by encapsulating the pigment in a microcapsule. The resulting pigment can be referred to as a resin-coated pigment. In this case, it is not necessary for all of the pigments included in the ink to be coated with the resin, and uncoated or partially coated pigments may be dispersed in the ink within a range that does not impair the effects of the present invention.

Examples of the method of dispersing the pigment using a dispersant include a method of dispersing the pigment using a known low molecular weight dispersant or high molecular weight dispersant, such as a surfactant.

As the dispersant, for example, an anionic surfactant, a cationic surfactant, an amphoteric surfactant, a nonionic surfactant, and the like can be used depending on the pigment.

RT-100 (nonionic surfactant) manufactured by Takemoto Oil & Fat Co., Ltd. and a sodium salt of naphthalene sulfonate formaldehyde condensate can also be suitably used as the dispersant.

The dispersant may be used alone or in combination of two or more.

### —Pigment Dispersion—

It is possible to obtain the ink by mixing the pigment with a material such as water or an organic solvent. Further, it is also possible to produce the ink by mixing the pigment with other components such as water and a dispersant to prepare a pigment dispersion, and then mixing the pigment dispersion with a material such as water or an organic solvent.

The pigment dispersion is obtained by mixing and dispersing water, the pigment, the pigment dispersant, and other components as required, and adjusting the particle size. Preferably, the dispersing is performed by a disperser.

The particle size of the pigment in the pigment dispersion is not particularly limited. However, from the viewpoints of improving the dispersion stability of the pigment and improving ejection stability and image quality such as image density, the maximum frequency of the particle size calculated as the maximum number is preferably 20 nm or more and 500 nm or less, more preferably 20 nm or more and 150 nm or less. The particle size of the pigment can be measured using a particle size analyzer (Nanotrac Wave-UT151 manufactured by MicrotracBEL Corp.).

If necessary, it is preferable to filter out coarse particles of the pigment dispersion using a filter, a centrifugal separation device, or the like, and degas the pigment dispersion.

The content of the pigment in the pigment dispersion is not particularly limited and can be appropriately selected depending on the purpose. From the viewpoints of obtaining good ejection stability and increasing image density, the content is preferably 0.1% by mass or more and 50% by mass or less, more preferably 0.1% by mass or more and 30% by mass or less.

### —Resin—

The resin is not particularly limited and can be appropriately selected depending on the purpose. Examples of the resin include a urethane resin, a polyester resin, an acrylic resin, a vinyl acetate resin, a styrene resin, a butadiene resin, a styrene-butadiene resin, a vinyl chloride resin, an acrylic styrene resin, and an acrylic silicone resin. Resin particles made of these resins may also be used.

The ink can be obtained by mixing the resin particles in the form of a resin emulsion, in which the resin particles are dispersed in water as a dispersion medium, with a material such as a coloring material or an organic solvent.

The resin particles that can be used may be appropriately synthesized or may be obtained as a commercially available product. The resin particles may be used alone or in combination of two or more.

The volume average particle size of the resin particles is not particularly limited and can be appropriately selected depending on the purpose. From the viewpoints of obtaining good fixability and high image hardness, the volume average particle size is preferably 10 nm or more and 1,000 nm or less, more preferably 10 nm or more and 200 nm or less, particularly preferably 10 nm or more and 100 nm or less.

The volume average particle size can be measured, for example, by using a particle size analyzer (Nanotrac Wave-UT151 manufactured by MicrotracBEL Corp.).

The content of the resin is not particularly limited and can be appropriately selected depending on the purpose. From the viewpoints of fixability and storage stability of the ink, the content of the resin is preferably 1% by mass or more and 30% by mass or less, more preferably 5% by mass or more and 20% by mass or less, relative to the total amount of the ink.

The physical properties of the ink are not particularly limited and can be appropriately selected depending on the purpose. For example, it is preferable that the viscosity, the surface tension, pH, and the like are within the following ranges.

The viscosity of the ink at 25° C. is preferably 5 mPa·s or more and 30 mPa·s or less, more preferably 5 mPa·s or more and 25 mPa·s or less, form the viewpoints of improving print density and character quality and obtaining good ejection properties. The viscosity described herein can be measured, for example, by using a rotational viscometer (RE-80L manufactured by Tokisangyo). The measurement conditions are as follows: 25° C., standard cone rotor (1°34′×R24), sample volume of 1.2 mL, rotation speed of 50 rpm, and measurement time of 3 minutes.

The surface tension of the ink is preferably 35 mN/m or less, more preferably 32 mN/m or less, at 25° C. from the viewpoints of ensuring good leveling of the ink on the recording medium and shortening the drying time of the ink.

The pH of the ink is preferably from 7 to 12, more preferably from 8 to 11, from the viewpoint of preventing corrosion of the metal member that contacts the ink.

### —Recording Medium—

The recording medium used for recording is not particularly limited. However, examples thereof include a plain paper, a glossy paper, a special paper, a fabric, a film, an OHP sheet, and a general-purpose printing paper.

The recording medium is not limited to the generally used recording media, and a building material such as a wallpaper, a flooring material, or a tile, a fabric for clothing such as a T-shirt, a textile, a leather, and the like can be used as appropriate. Further, by adjusting the configuration of the path for transporting the recording medium, a ceramic, glass, metal, and the like can also be used.

The use of the ink according to an embodiment of the present invention is not particularly limited and can be appropriately selected according to the purpose. For example, the ink can be applied to a printed matter, a paint, a coating material, an undercoat, and the like. Further, the ink can be used not only to form a two-dimensional character or image, but also as a material for three-dimensional fabricating to form a three-dimensional image (three-dimensional fabricated object).

A known three-dimensional fabricating apparatus can be used for forming a three-dimensional fabricated object without particular limitations. For example, the apparatus equipped with an ink storage device, a supply device, an ejection device, a drying device, and the like can be used. Examples of the three-dimensional fabricated object include one obtained by applying multiple layers of the ink. Further, the three-dimensional fabricated object includes a molded article obtained by processing a structure in which the ink is applied onto a substrate such as a recording medium. The molded article is, for example, a product obtained by subjecting a recorded matter or structure formed into a sheet or film shape to a molding process such as heat stretching or punching, and is suitably used in an application where the surface is to be molded after decoration, such as, for example, a panel for a meter or an operation unit for an automobile, office automation equipment, electric or electronic equipment, or a camera.

Further, in the terminology of the present disclosure, image formation, recording, character printing, printing, and the like are all considered synonymous.

A recording medium, media, and a printed matter are all considered synonymous.

### [Image Forming Method and Image Forming Apparatus]

The liquid ejection apparatus according to an embodiment of the present invention can be applied to an image forming apparatus and an image forming method.

The image forming apparatus includes the liquid ejection apparatus, and also includes a white ink applying device for applying white ink to a fabric, and a color ink applying device for applying color ink to an area to which the white ink has been applied, and may include a white ink storing device for storing the white ink, a color ink storing device for storing the color ink, and other devices, as necessary.

The image forming method includes a white ink applying step of applying white ink to a fabric, and a color ink applying step of applying color ink to an area to which the white ink has been applied, and may include other steps as necessary.

The white ink applying step can be suitably performed by the white ink applying device, the color ink applying step can be suitably performed by the color ink applying device, and the other steps can be suitably performed by the other devices.

The image forming apparatus and the image forming method in the present specification refer to an apparatus capable of ejecting the white ink, the color ink, and, if necessary, other various treatment liquids, and the like onto a recording medium, and a method of performing recording using the apparatus, respectively.

The recording medium refers to a material to which the white ink, the color ink, and, if necessary, the other various treatment liquids can be attached even temporarily, and a fabric is preferable as the recording medium.

### <Fabric>

The fabric is not particularly limited and can be appropriately selected depending on the purpose. Examples of the fabric include a cotton broadcloth and a polyester tropical fabric.

### <White Ink Applying Step, White Ink Applying Device, Color Ink Applying Step, and Color Ink Applying Device>

The white ink applying step is a step of applying white ink to the fabric.

The white ink applying device is a device for applying white ink to the fabric.

The color ink applying step is a step of applying color ink to an area to which the white ink has been applied.

The color ink applying device is a device for applying color ink to an area to which the white ink has been applied.

These applying steps (devices) are not particularly limited and can be appropriately selected depending on the purpose. However, examples thereof include an inkjet method, a blade coating method, a gravure coating method, a bar coating method, a roll coating method, a dip coating method, a curtain coating method, a slide coating method, a die coating method, and a spray coating method. Of these, an inkjet method is preferable.

### <Other Steps and Other Devices>

The other steps are not particularly limited and can be appropriately selected depending on the purpose. However, examples thereof include a pre-treatment liquid applying step, a drying step, and a post-treatment liquid applying step.

The other devices are not particularly limited and can be appropriately selected depending on the purpose. However, examples thereof include a pre-treatment liquid applying device, a drying device, and a post-treatment liquid applying device.

### <<Pretreatment Liquid Applying Step and Pretreatment Liquid Applying Device>>

The pretreatment liquid applying step is a step of applying a pretreatment liquid to the fabric.

The pretreatment liquid applying device is a device for applying a pretreatment liquid to the fabric.

The pretreatment liquid applying device is not particularly limited and can be appropriately selected depending on the purpose. For example, a similar applying device as described above can be used.

### <<Drying Step and Drying Device>>

The drying step is a step of drying the fabric to which the white ink or the color ink has been applied.

The drying device includes a device for drying the fabric to which the white ink or the color ink has been applied.

The drying step can be suitably performed by the drying device.

The drying step (device) can be referred to as a heating step (device).

The drying (heating) step and the drying (heating) device are not particularly limited. However, for example, a hot air heater, an infrared heater, or the like can be used. Heating and drying can be performed before, during, or after printing, or the like.

### <<Post-Treatment Liquid Applying Step and Post-Treatment Liquid Applying Device>>

The post-treatment liquid applying step is a step of applying a post-treatment liquid to the fabric to which the color ink has been applied.

The post-treatment liquid applying device is a device for applying a post-treatment liquid to the fabric to which the color ink has been applied.

The post-treatment liquid applying step can be suitably performed by the post-treatment liquid applying device.

The post-treatment liquid applying device is not particularly limited and can be appropriately selected depending on the purpose. For example, a similar applying device as described above can be used.

One aspect of the post-treatment liquid applying device includes a liquid storage unit containing the post-treatment liquid and a liquid ejection head, as the case for the ink such as black (K), cyan (C), magenta (M), or yellow (Y), and ejects the post-treatment liquid with an inkjet recording method.

The image forming apparatus can be applied to various recording apparatuses using the inkjet recording method, such as, for example, a printer, a facsimile machine, a copying machine, a printer/fax/copier combination machine, or a three-dimensional fabricating apparatus.

The image forming method and the image forming apparatus are not limited to those in which a meaningful image such as a character or a figure is visualized by the ink. Examples of the image forming method and the image forming apparatus include those that form a pattern or the like such as a geometric design and those that model a three-dimensional image.

Unless otherwise specified, examples of the image forming apparatus include both a serial-type apparatus in which the ejection head is moved and a line-type apparatus in which the ejection head is not moved. Further, examples of the image forming apparatus include not only a desktop type, but also a wide-format recording apparatus that can perform printing on an A0-sized fabric, and a continuous-feed printer that can use, for example, a rolled-up fabric as the recording medium.

An image forming apparatus according to embodiments of the present invention is described with reference to the drawings.

However, the present invention is not limited to these embodiments.

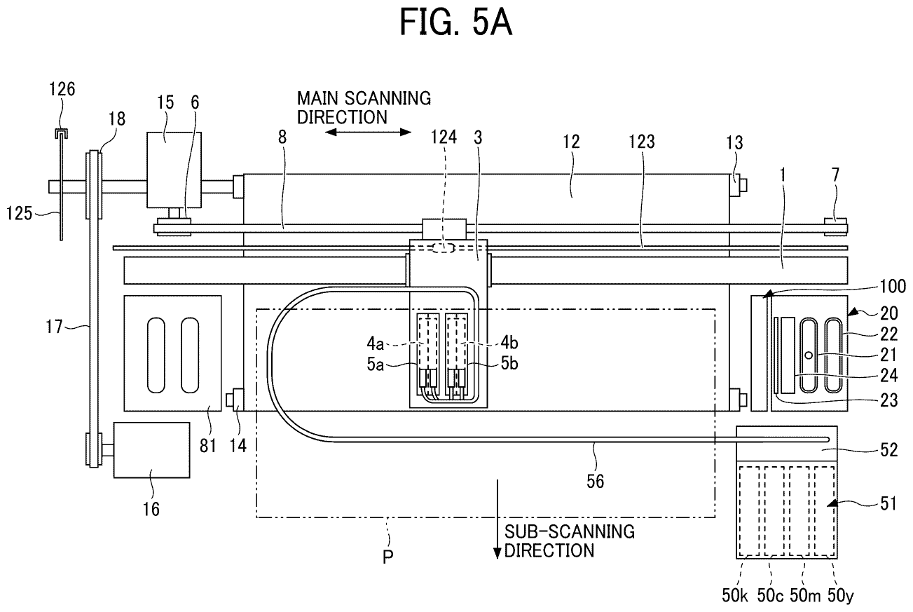

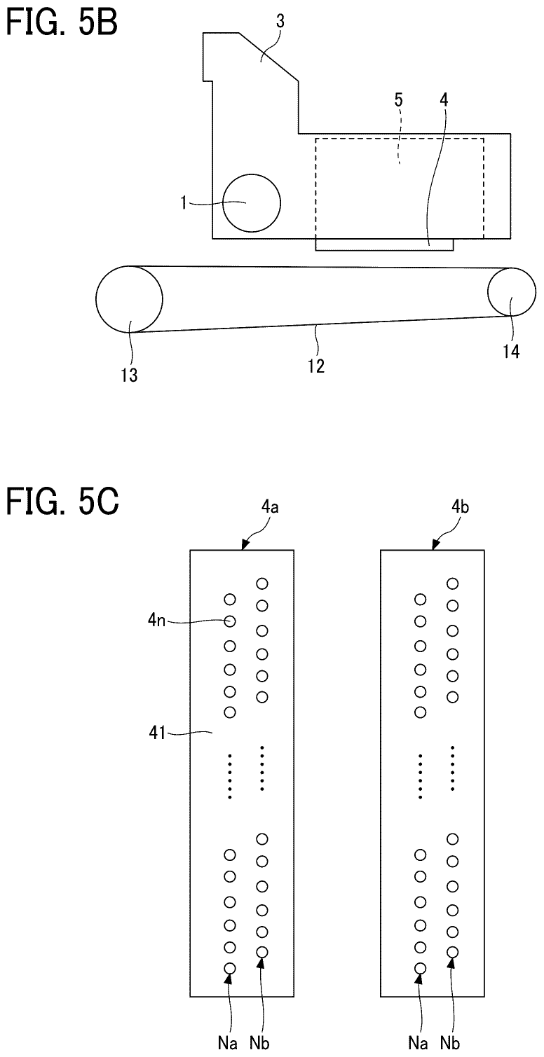

FIG. 5A is a schematic plan view of a mechanism unit of an image forming apparatus according to an embodiment of the present invention. FIG. 5B is a schematic side view of a mechanism unit of an image forming apparatus according to an embodiment of the present invention. FIG. 5C is a schematic plan view of an inkjet head of an image forming apparatus according to an embodiment of the present invention. Note that FIG. 5C illustrates a state in which the head is seen through from above.

The image forming apparatus in FIG. 5A is a serial-type inkjet recording apparatus, and a carriage 3 is supported so as to be movable in a main scanning direction by a main guide member 1 and a sub-guide member that are bridged across left and right side plates. A main scanning motor 15 causes the carriage 3 to reciprocally move in the main scanning direction (carriage moving direction) via a timing belt 8 stretched between a driving pulley 6 and a driven pulley 7.

The carriage 3 is equipped with, as image forming devices, two recording heads 4a and 4b, each forming a liquid ejection head, and a head tank 5a and a head tank 5b for supplying liquids to the recording head 4a and the recording head 4b, respectively.

As illustrated in FIG. 5C, the recording head 4a and the recording head 4b (which may be collectively referred to as “recording heads 4”) each include two nozzle rows Na and Nb in each of which a plurality of nozzles 4n are arranged. The nozzle row Na and the nozzle row Nb are arranged in a staggered manner with their positions shifted to each other in the nozzle arrangement direction.

One nozzle row Na in the recording head 4a ejects black (K) liquid droplets, and the other nozzle row Nb ejects cyan (C) liquid droplets. Further, one nozzle row Na in the recording head 4b ejects magenta (M) liquid droplets, and the other nozzle row Nb ejects yellow (Y) liquid droplets.

Note that, as the recording heads 4, it is also possible to use, for example, a single recording head (liquid ejection head) having a nozzle surface 41 provided with a plurality of nozzle rows, each row having multiple nozzles arranged and ejecting droplets of each color.

The carriage 3 includes four recording heads, two of which can eject white (Wh) liquid droplets. It is also possible to include two carriages 3 (carriage 3 and carriage 3′), one dedicated to the color ink and the other to the white ink.

Further, the liquid ejection head as the recording heads 4 may be, for example, a piezoelectric actuator such as a piezoelectric element, or a thermal actuator that utilizes a phase change caused by film boiling of the liquid using an electrothermal conversion element such as a heating resistor.

The head tanks 5a and 5b are configured by a pair of tank units corresponding to two nozzle rows Na and Nb of the recording heads 4a and 4b, respectively. Thus, the recording heads 4 are configured to have a plurality of tank units.

In the apparatus main body, a cartridge holder 51 is disposed to which main tanks (liquid cartridges) 50 (50y, 50m, 50c, and 50k) storing liquids of each color are attached in a replaceable manner. This cartridge holder 51 is provided with a liquid delivery pump unit 52. The liquid delivery pump unit 52 supplies the liquids of each color from the main tanks 50 to the head tank 5a and head tank 5b via supply tubes (also referred to as “liquid supply paths”) 56 of each color.

On the other hand, a conveyance belt 12 is provided as a conveyance device for taking up a paper sheet P and conveying it to a position facing the recording heads 4. This conveyance belt 12 is an endless belt and is stretched between a conveyance roller 13 and a tension roller 14.

The conveyance belt 12 moves in a circular motion in the sub-scanning direction as the conveyance roller 13 is rotationally driven by a sub-scanning motor 16 via a timing belt 17 and a timing pulley 18. This conveyance belt 12 takes up the paper sheet P by being charged by a charging roller while rotationally moving, or by using a suction device.

If the recording medium is not paper (a fabric, etc.), the recording medium is placed on a flat platen instead of the conveyance belt, and the platen is moved by the sub-scanning motor.

A maintenance recovery mechanism 20, which is one of recovery operation devices for performing a recovery operation for the recording heads 4, is disposed on one side of the carriage 3 in the main scanning direction, beside the conveyance belt 12. On the other side of the carriage 3 in the main scanning direction, a blank ejection receiver 81 for performing blank ejection from the recording heads 4 is disposed beside the conveyance belt 12.

The maintenance recovery mechanism 20 is configured by, for example, a suction cap 21 that caps the nozzle surface 41 of the recording heads 4, a moisture retention cap 22, a wiper member 23 that wipes the nozzle surface 41, and a blank ejection receiver 24 to which droplets that do not contribute to image formation are ejected. The blank ejection can be also performed to the suction cap 21.

Further, in an area capable of facing the recording heads 4, but outside the recording area, between the conveyance belt 12 and the maintenance recovery mechanism 20, an ejection detection unit 100 that detects the presence or absence of droplet ejection (ejection state) is disposed.

Note that the ejection detection unit 100 includes an electrode plate, for example, in a case where the ejection detection unit 100 is configured as an ejection detection device that detects the presence or absence of droplet ejection by detecting an electrical change caused by droplets landing on the electrode plate. Further, in a case where the ejection detection unit 100 is configured as an ejection detection device that detects the presence or absence of droplet ejection using laser light, the ejection detection unit 100 includes a light emitting unit, a light receiving unit, and the like.

An encoder scale 123 having a predetermined pattern formed thereon is stretched between side plates of the carriage 3 along the main scanning direction, and the carriage 3 is provided with an encoder sensor 124 including a transmission type photosensor that reads the pattern of the encoder scale 123. The encoder scale 123 and the encoder sensor 124 constitute a linear encoder (main scanning encoder) that detects the movement of the carriage 3.

A code wheel 125 is attached to the shaft of the conveyance roller 13, and an encoder sensor 126 including a transmission type photosensor that detects a pattern formed on this code wheel 125 is provided. The code wheel 125 and the encoder sensor 126 constitute a rotary encoder (sub-scanning encoder) that detects the amount of movement and the position of movement of the conveyance belt 12.

In the image forming apparatus thus configured, the paper sheet P is fed onto and taken up by the charged conveyance belt 12, and is conveyed in the sub-scanning direction by the rotational movement of the conveyance belt 12.

Then, while the carriage 3 is moved in the main scanning direction, the recording heads 4 are driven in response to an image signal, so that ink droplets are ejected onto the stationary paper sheet P to record one line. Then, after the paper sheet P is conveyed by a predetermined distance, the next line is recorded.

Upon receiving a recording end signal or a signal indicating that the rear end of the paper sheet P has reached the recording area, the recording operation is terminated, and the paper sheet P is discharged to a paper discharge tray.

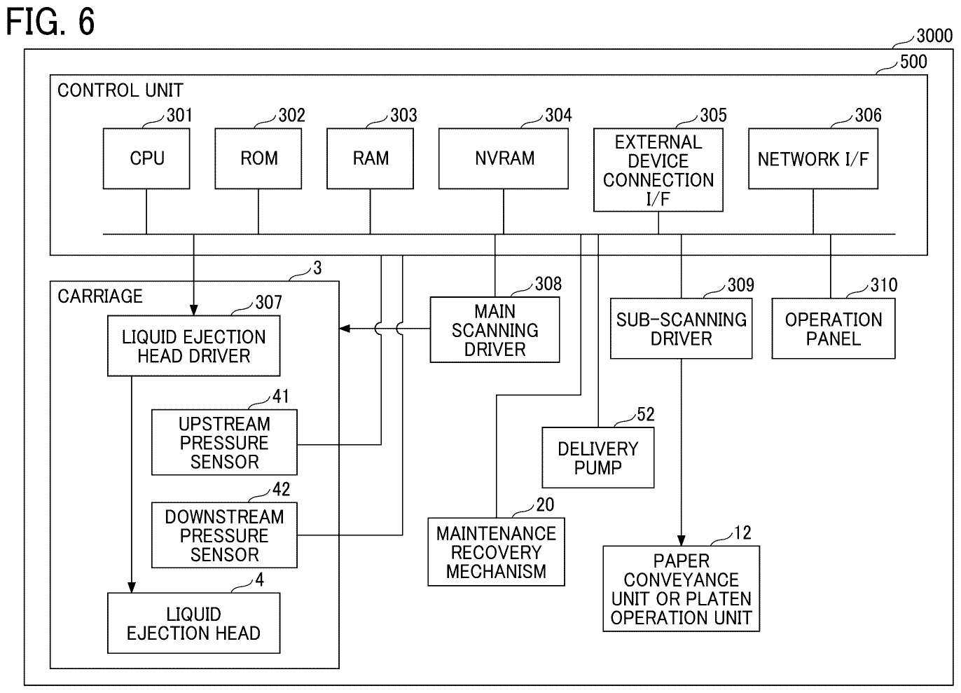

FIG. 6 is a diagram illustrating a hardware configuration of an image forming apparatus according to an embodiment of the present invention.

A controller 500 includes a central processing unit (CPU) 301, a read only memory (ROM) 302, a random access memory (RAM) 303, a non-volatile memory (NVRAM) 304, an external device connection interface (I/F) 305, and a network I/F 306.

The CPU 301 controls an image forming apparatus 3000.

The ROM 302 stores programs including a program for causing the CPU 301 to execute control according to embodiments of the present invention, and other fixed data.

The RAM 303 temporarily stores image data and the like.

The NVRAM 304 retains data even when the power to the apparatus is shut off.

The external device connection I/F 305 and the network I/F 306 send and receive data and signals which are used when the data are received from the outside.

The controller 500 drives and controls a liquid ejection head driver 307 of the carriage 3 to drive the liquid ejection heads 4 via the liquid ejection head driver 307.

The controller 500 drives and controls a main scanning driver 308 to drive the carriage 3 via the main scanning driver 308.

The controller 500 drives and controls a sub-scanning driver 309 to drive a paper conveyance unit or a platen operation unit 12 via the sub-scanning driver 309.

The controller 500 drives and controls the upstream and downstream pressure sensors 41 and 42 of the carriage 3, the maintenance recovery mechanism 20, and an operation panel 310 that inputs and displays information required for the apparatus.

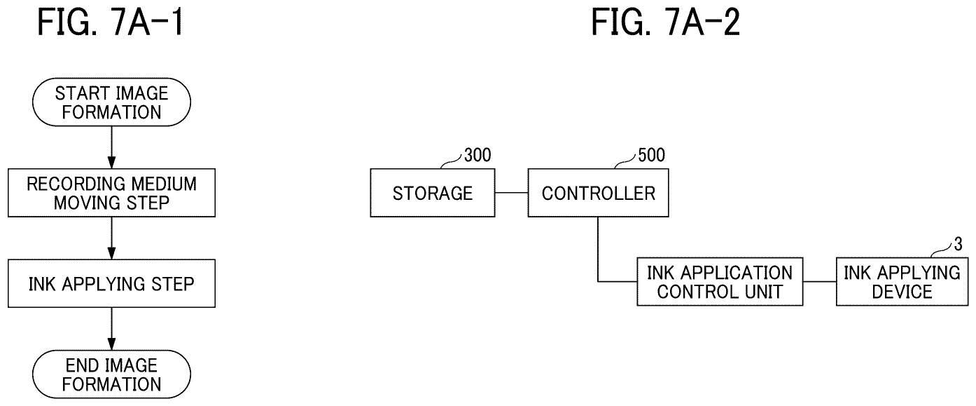

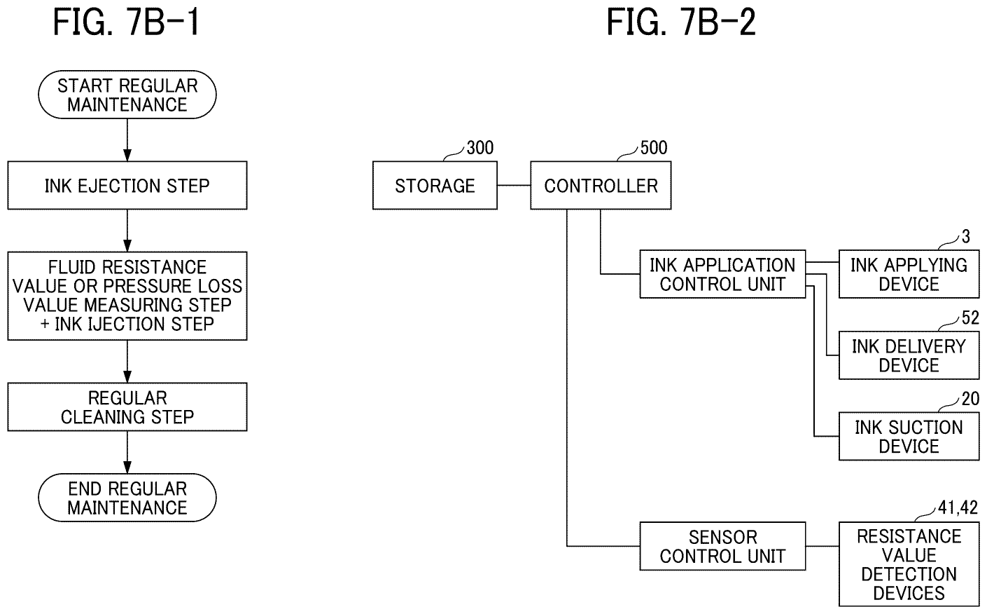

FIGS. 7A-1 and 7A-2 are a flowchart and a block diagram, respectively, relating to an image formation function of an image forming apparatus according to an embodiment of the present invention.

A storage 300 is a hard disk drive (HDD) or the like and stores data such as an image to be printed.

A main controller 500 is a CPU or the like and gives an instruction to the storage unit and each control unit.

An ink applying device 3 is an inkjet head or the like and applies the ink to a target object.

An ink application control unit of the controller 500 controls the ink applying device 3 and driving of a main scanning motor and a sub scanning motor.

FIGS. 7B-1 and 7B-2 area flowchart and a block diagram, respectively, relating to a maintenance function of an image forming apparatus according to an embodiment of the present invention.

The ink application control unit of the controller 500 controls the ink applying device 3, an ink delivery device 52, and an ink suction device 20.

The ink suction device 20 sucks the ink from the ink applying device 3 (maintenance module).

The ink delivery device 52 supplies the ink to the ink applying device 3 (supply module).

Resistance value detection devices 41 and 42 are pressure sensors and detect the fluid resistance value when the ink flows.

A sensor control unit of the controller 500 compares the fluid resistance value detected by the resistance value detection devices 41 and 42 with the threshold value or the like, and the ink application control unit controls the ink applying device 3, the ink delivery device 52, and the ink suction device 20 based on the comparison result by the sensor control unit.

The liquid ejection apparatus according to an embodiment of the present invention can be applied to a three-dimensional fabricating apparatus (3D printer). A three-dimensional fabricating apparatus according to an embodiment of the present invention is described below.

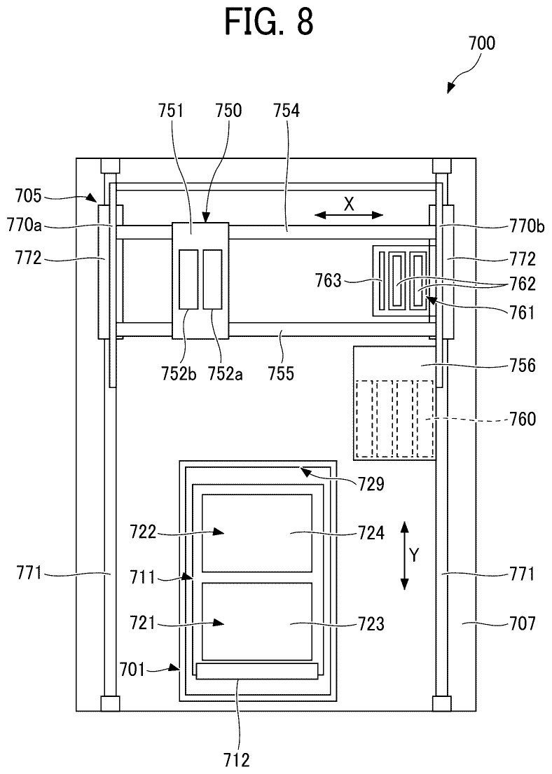

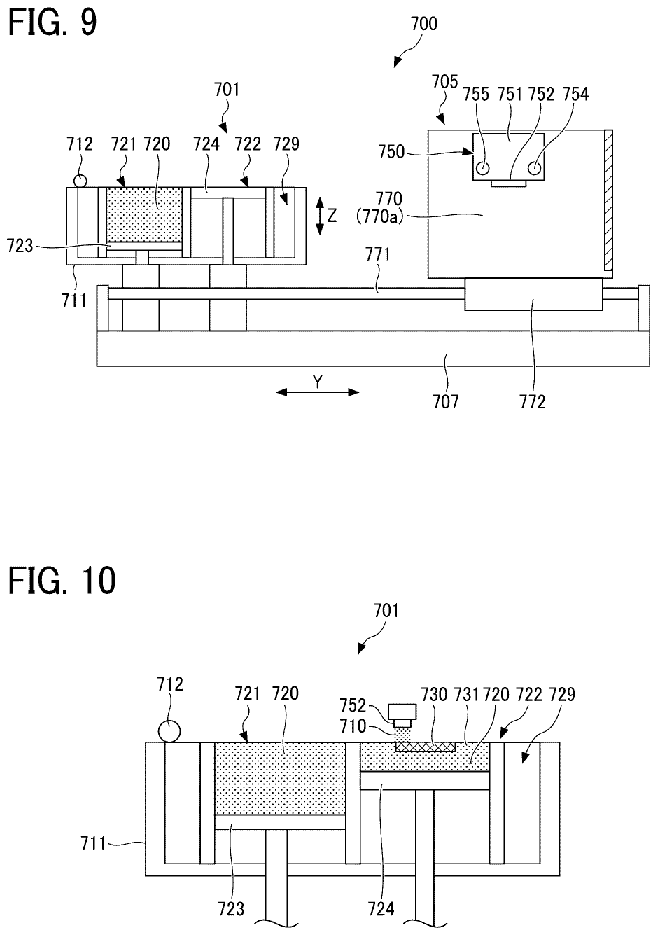

FIG. 8 is a schematic plan view of a three-dimensional fabricating apparatus according to an embodiment of the present invention. FIG. 9 is a schematic cross-sectional view of the three-dimensional fabricating apparatus in FIG. 8 as viewed from the right side in FIG. 8. FIG. 10 is a schematic cross-sectional view of a powder holder in FIG. 9. FIG. 11 is a perspective explanatory view of a main part of the three-dimensional fabricating apparatus according to the present embodiment. Note that FIG. 10 is a schematic cross-sectional view taken along a section A-A in FIG. 11.

A three-dimensional fabricating apparatus 700 is a powder fabricating apparatus. This three-dimensional fabricating apparatus 700 includes a powder holder 701 in which a layered fabricated object 730 is formed by bonding a powder 720, and a fabricating device 705 that ejects a fabricating liquid 710 onto a powder layer of the powder 720 spread as a layer in the powder holder 701.

The liquid in the liquid ejection apparatus according to an embodiment of the present invention can be used as the fabricating liquid 710.

The powder holder 701 and the fabricating device 705 are relatively movable in the Y direction indicated by an arrow (hereinafter simply referred to as “Y direction”; the same applies to the other directions X and Z), and a liquid ejection unit 750 of the fabricating device 705 is relatively movable in the X direction with respect to the powder holder 701.

The powder holder 701 includes a powder storage chamber 711 and a flattening roller 712 that is a rotating member serving as a flattening member (i.e., recoater). The flattening member may be, for example, a plate-like member (blade) instead of the rotating member.

The powder storage chamber 711 includes a fabricating chamber 722 in which the layered fabricated object 730 is stacked to form a three-dimensional fabricated object, a supply chamber 721 that stores the powder 720 to be supplied to the fabricating chamber 722, and a surplus powder collecting chamber 729 that collects a surplus of the powder 720 supplied to the fabricating chamber 722. The fabricating chamber 722 and the supply chamber 721 are arranged side by side in the Y direction.

A supply stage 723 constituting the bottom of the supply chamber 721 can move up and down in the vertical direction (height direction). The powder 720, which is a fabricating material, is placed on the supply stage 723. A fabricating stage 724, which constitutes the bottom of the fabricating chamber 722, can also move up and down in the vertical direction (height direction). The three-dimensional fabricated object in which the layered fabricated objects 730 are stacked is formed on the fabricating stage 724.

FIG. 12 is a block diagram illustrating an outline of a controller in a three-dimensional fabricating apparatus. A controller 5000 controls the driving of a supply stage lifting motor 2700 to move the supply stage 723 up and down in the Z direction (height direction). Further, the controller 5000 controls the driving of a fabricating stage lifting motor 2800 to move the fabricating stage 724 up and down in the Z direction (height direction).

The side surface of the supply stage 723 is disposed so as to contact the inner surface of the supply chamber 721.

The side surface of the fabricating stage 724 is also disposed so as to contact the inner surface of the fabricating chamber 722. The upper surfaces of the supply stage 723 and the fabricating stage 724 are kept horizontal.

In the supply chamber 721, a powder supply device 5540 is disposed. During the initial operation of fabricating or when the amount of powder in the supply chamber 721 decreases, the controller 5000 controls the driving of a powder supply driving unit 5170 to supply the powder 720 in a tank that constitutes the powder supply device 5540 to the supply chamber 721. Examples of a powder transport method for supplying the powder include a screw conveyor method using a screw and a pneumatic transport method using air.

The flattening roller 712 has a length in an axial direction (length in the X direction) longer than the inner width of the fabricating chamber 722 and the supply chamber 721, and is disposed so as to be reciprocally movable relative to the stage surface in the Y direction along the stage surface (the surface on which the powder 720 is placed) of the fabricating stage 724. The controller 5000 controls the driving of a flattening roller reciprocating motor 2500, so that the flattening roller 712 moves in the horizontal direction so as to follow the upper surfaces of the supply stage 723 and the fabricating stage 724. When supplying the powder 720 to the fabricating chamber 722, the flattening roller 712 moves in the horizontal direction, so that a part of the powder 720 stored on the supply stage 723 of the supply chamber 721 is pushed away in the horizontal direction by the flattening roller 712, and transported and supplied to the fabricating chamber 722. At this time, the surface (upper surface) of the powder 720 supplied to the fabricating chamber 722 is leveled and flattened by the flattening roller 712, forming a powder layer of predetermined thickness 731 having a predetermined layer thickness.

Further, the flattening roller 712 is driven and rotated by a flattening roller rotating motor 2600. The flattening roller 712 reciprocally moves in the horizontal direction so as to pass above the supply chamber 721 and the fabricating chamber 722 while being rotated by the flattening roller rotating motor 2600. As a result, the powder 720 above the supply chamber 721 is pushed away by the flattening roller 712 and transported and supplied to the fabricating chamber 722. The flattening roller 712 transports and flattens the powder 720 while passing above the fabricating chamber 722, thereby forming the powder layer of predetermined thickness 731 having a desired thickness.

The fabricating device 705 includes the liquid ejection unit 750 that ejects (applies) the fabricating liquid 710 that bonds the powder 720 to the powder layer 731 of a predetermined thickness 731 on the fabricating stage 724 and forms the layered fabricated object 730 as a layered structure in which the powder 720 is bonded to each other.

The liquid ejection unit 750 includes a carriage 751 and two (or one or three or more) liquid ejection heads, a first head 752a and a second head 752b (when no distinction is required, they are referred to as “heads 752”), mounted on the carriage 751.

The carriage 751 is supported by a first guide member 754 and a second guide member 755 so as to be movable in the X direction that is the main scanning direction. Both ends in the X direction of the first guide member 754 and the second guide member 755 are supported by support members 775 (a first support member 775a and a second support member 775b), and are held so as to be able to move up and down with respect to side plates 770 (a first side plate 770a and a second side plate 770b). This carriage 751 reciprocally moves in the X direction, which is the main scanning direction, via a pulley and a belt by an X direction scanning motor constituting a main scanning direction moving mechanism 5500.

The heads 752 each have two nozzle rows, in each of which a plurality of nozzles are arranged, for ejecting the fabricating liquid 710. The two nozzle rows of the first head 752a eject a cyan fabricating liquid and a magenta fabricating liquid, respectively. The two nozzle rows of the second head 752b eject a yellow fabricating liquid and a black fabricating liquid, respectively. The configuration of the heads 752 and the color of the fabricating liquid to be ejected are not limited to these configurations.

As illustrated in FIG. 8, a plurality of tanks 760 storing the cyan fabricating liquid, the magenta fabricating liquid, the yellow fabricating liquid, and the black fabricating liquid, respectively, are mounted on a tank mounting unit 756, and the fabricating liquids of each color are supplied to the heads 752 via supply tubes or the like.

A maintenance mechanism 761 that performs maintenance and recovery of the heads 752 of the liquid ejection unit 750 is disposed on one side (the right side in FIG. 8) of the movement range of the carriage 751 in the X direction. The maintenance mechanism 761 includes a cap 762 and a wiper 763. In the maintenance mechanism 761, the cap 762 is brought into close contact with the nozzle surface (the surface on which the nozzles are formed) of the heads 752 to suck out the fabricating liquid from the nozzles. This is for the purpose of discharging the powder 720 clogged in the nozzle and discharging the fabricating liquid increased in viscosity. Thereafter, in the maintenance mechanism 761, the nozzle surface is wiped with the wiper 763 to form the meniscus in the nozzles. Further, in the maintenance mechanism 761, the cap 762 covers the nozzle surface of the heads 752 during a period when the fabricating liquid is not ejected, thereby preventing the powder 720 from entering the nozzles and the fabricating liquid 710 from drying out.

The fabricating device 705 includes a slider unit 772 movably held by a guide member 771 disposed on a base member 707, and the entire fabricating device 705 is reciprocally movable in the Y direction (sub-scanning direction) perpendicular to the X direction. The entire fabricating device 705 reciprocally moves in the Y direction by a sub-scanning direction moving mechanism 5520.

The liquid ejection unit 750 is disposed so as to be movable up and down in the Z direction together with the first guide member 754 and the second guide member 755, and is moved up and down in the Z direction by an ejection unit lifting mechanism 5510.

Next, an outline of the controller 5000 of the three-dimensional fabricating apparatus 700 is described with reference to FIG. 12.

The controller 5000 includes a main control unit 5000A including a CPU 5010, a ROM 5020, and a RAM 5030. The CPU 5010 controls the entire three-dimensional fabricating apparatus 700. The ROM 5020 stores programs including a program for causing the CPU 5010 to execute control of three-dimensional fabricating operations, and other fixed data, and the RAM 5030 temporarily stores fabricating data and the like.

The controller 5000 includes a non-volatile memory (NVRAM) 5040 that retains data even when the power to the apparatus is shut off. Further, the controller 5000 includes an application specific integrated circuit (ASIC) 5050 that performs image processing including, for example, various types of signal processing on image data, and in addition, processing of input and output signals used to control the entire apparatus.

The controller 5000 includes an external I/F 5060 for transmitting and receiving data and signals used when receiving fabricating data from an external fabricating data creating device 800. The fabricating data creating device 800 is a device that creates fabricating data in which a final form of the three-dimensional fabricating object is sliced into individual layered fabricated objects, and is configured by, for example, an information processing device such as a personal computer. Further, the controller 5000 includes an input/output unit (I/O) 5070 that receives detection signals from various sensors. The input/output unit 5070 receives a detection signal from a temperature and humidity sensor 5600 or the like that detects the temperature and humidity as environmental conditions of the apparatus, and detection signals from other sensors.

The controller 5000 includes a head driving control unit 5080 that drives and controls a head 5200 of the liquid ejection unit 750.

Further, the controller 5000 includes a main scanning direction driving unit 5100 and a sub-scanning direction driving unit 5120. The main scanning direction driving unit 5100 drives a motor constituting the main scanning direction moving mechanism 5500 that moves the carriage 751 of the liquid ejection unit 750 in the X direction (main scanning direction). The sub-scanning direction driving unit 5120 drives a motor constituting the sub-scanning direction moving mechanism 5520 that moves the fabricating device 705 in the Y direction (sub-scanning direction).

Further, the controller 5000 includes an ejection unit lifting driving unit 5110 that drives a motor constituting the ejection unit lifting mechanism 5510 for moving (lifting and lowering) the carriage 751 of the liquid ejection unit 750 in the Z direction. The lifting and lowering in the Z direction can also be achieved by a configuration of lifting and lowering the entire fabricating unit 705.

The controller 5000 includes a supply stage driving unit 5130 that drives the supply stage lifting motor 2700 for lifting and lowering the supply stage 723, and a fabricating stage driving unit 5140 that drives the fabricating stage lifting motor 2800 for lifting and lowering the fabricating stage 724. Further, the controller 5000 includes a flattening reciprocation driving unit 5150 that drives a flattening roller reciprocating motor 2500 for moving the flattening roller 712, and a flattening rotation driving unit 5160 that drives a flattening roller rotating motor 2600 for driving and rotating the flattening roller 712.

The controller 5000 includes the powder supply driving unit 5170 that drives the powder supply device 5540 for supplying the powder 720 to the supply chamber 721, and a maintenance driving unit 5180 that drives a maintenance mechanism 6100 of the liquid ejection unit 750.

An operation panel 5220 is connected to the controller 5000 for allowing the user to input necessary information and for displaying information to the user.

As an example of a step for supplying the powder 720 to the fabricating chamber 722, the supply stage 723 is lifted by 200 [μm], the fabricating stage 724 is lowered by 100 [μm], and the flattening roller 712 is moved in the right direction in FIG. 10. As a result, the powder 720 gained by lifting the supply stage 723 is pushed away by the flattening roller 712 and moved in the right direction in FIG. 10, so that a new powder layer gained by lifting 100 [μm] can be deposited in the fabricating chamber 722. Of the powder 720 pushed away and transported by the flattening roller 712, the surplus powder 720 that does not fit into the fabricating chamber 722 is collected in the surplus powder collecting chamber 729.

The powder 720 that can be used may be, for example, a stainless steel powder coated with a resin material.

Examples of the stainless steel powder include a gas atomized powder PSS316L-20 μm grade (manufactured by Sanyo Special Steel Co., Ltd.).

The resin material used for the coating is not limited to those described above. Examples of the resin material include a polyvinyl alcohol (PVA-205C and PVA-220C manufactured by Kuraray Co., Ltd.), polyacrylic acid (JURYMER AC-10 manufactured Toagosei Co., Ltd.), sodium polyacrylate (JURYMER AC-103P manufactured by Toagosei Co., Ltd.), an acetoacetyl-modified polyvinyl alcohol (Gohsenx Z-300, Gohsenx Z-100, Gohsenx Z-200, Gohsenx Z-205, Gohsenx Z-210, and Gohsenx Z-220, manufactured by Nippon Synthetic Chemical Industry Co., Ltd.), a carboxy-modified polyvinyl alcohol (Gohsenx T-330, Gohsenx T-350, and Gohsenx T-330T, manufactured by Nippon Synthetic Chemical Industry Co., Ltd.), a butanediol-vinyl alcohol copolymer (Nichigo G-Polymer OKS-8041 manufactured by Nippon Synthetic Chemical Industry Co., Ltd.), carboxymethylcellulose (CELOGEN 5A manufactured by Daiichi Kogyo Co., Ltd.), starch (HISTARD PSS-5 manufactured by Sanwa Starch Co., Ltd.), and gelatin (beMatrix Gelatin manufactured by Nitta Gelatin Inc.).

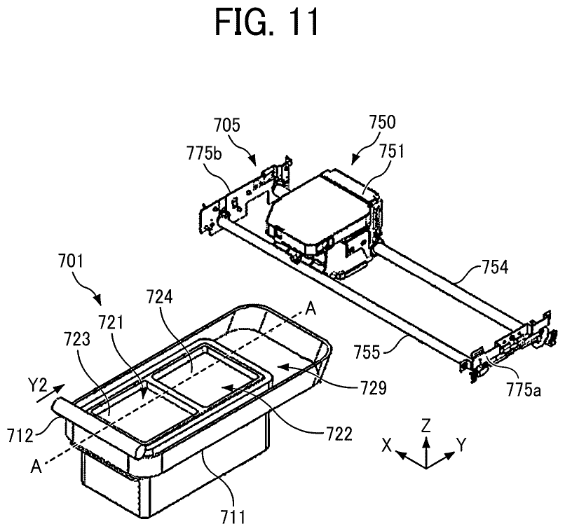

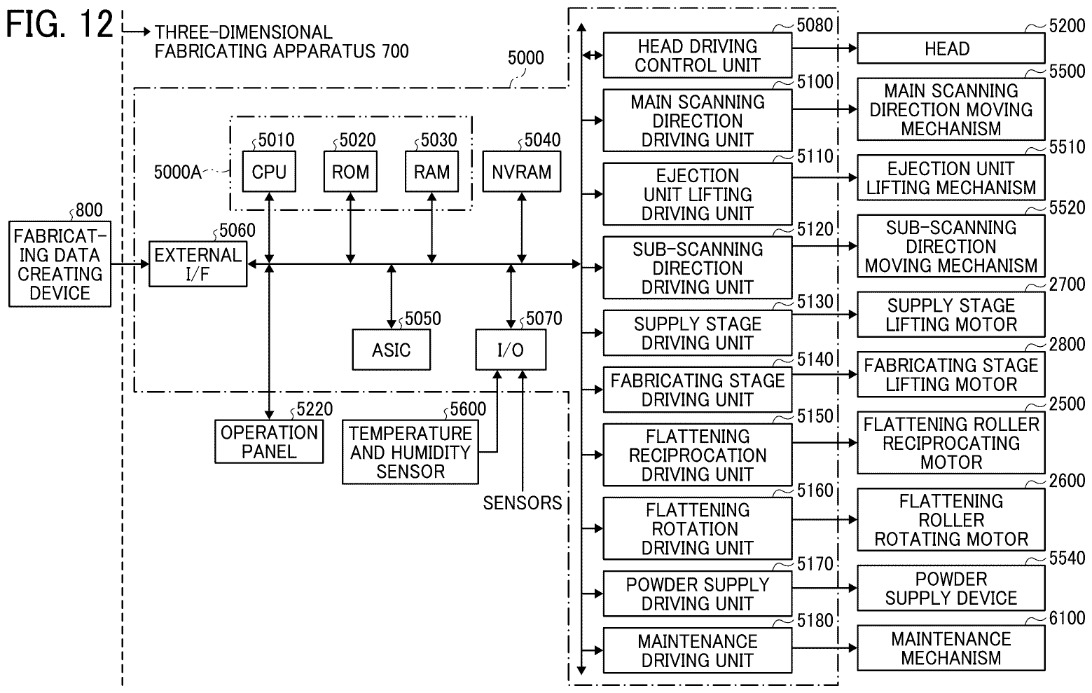

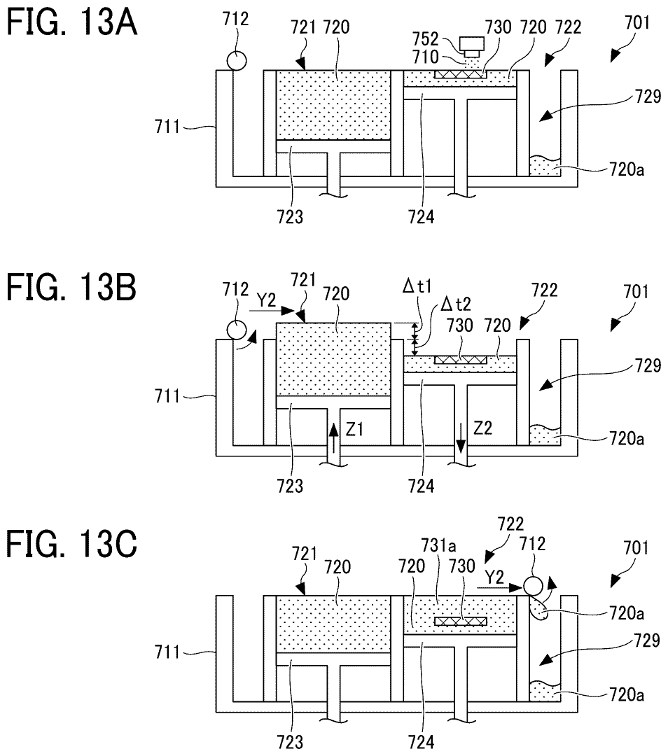

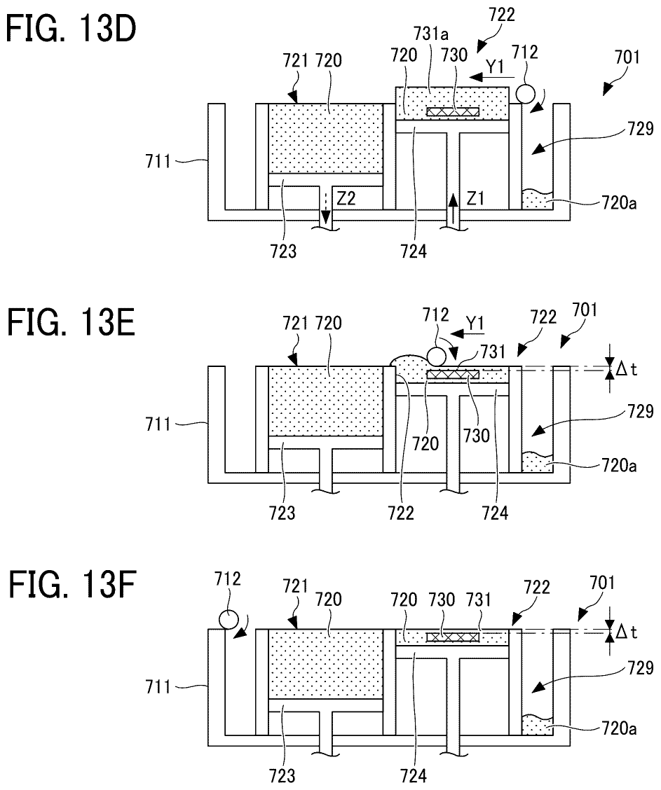

Next, an example of a powder layer forming operation in the three-dimensional fabricating apparatus is described with reference to FIG. 13.

FIG. 13 is an explanatory diagram for describing an example of the powder layer forming operation according to the present embodiment.

First, FIG. 13A illustrates a state in which one or more layers of the layered fabricated objects 730 are formed on the fabricating stage 724 in the fabricating chamber 722.

When forming the powder layer of predetermined thickness 731 for forming the next layered fabricated object 730 on the uppermost layered fabricated object 730, as illustrated in FIG. 13B, the supply stage 723 in the supply chamber 721 is lifted in a “Z1” direction (upward) by an amount of movement “z1”. At the same time, the fabricating stage 724 in the fabricating chamber 722 is lowered in a “Z2” direction (downward) by an amount of movement “z2”. The movement amounts “z1” and “z2” are set to a value larger than a target thickness “Δt” of the powder layer of predetermined thickness 731 (the thickness of the layered fabricated object 730 formed by supplying the fabricating liquid). For example, the target thickness “Δt” is preferably about several tens to hundred [μm].

By lifting the supply stage 723 by “z1”, the height of the top surface of the powder 720 on the supply stage 723 becomes higher than the upper end of the side wall constituting the supply chamber 721 by “Δt1(≈z1)”. Further, by lowering the fabricating stage 724 by “z2”, the height of the top surface of the powder 720 on the fabricating stage 724 becomes lower than the upper end of the side wall constituting the fabricating chamber 722 by “Δt2(≈z2)”.

The relationship between the movement amount “z1” of the supply stage 723 and the movement amount “z2” of the fabricating stage 724 is provided by “z1≥z2”. Further, the upper surface of the supply stage 723 and the upper surface of the fabricating stage 724 have the same area. This allows a sufficient amount of the powder 720 to be supplied from the supply chamber 721 to the fabricating chamber 722 to cover, with the powder 720, the entire gap above the top surface of the powder 720 in the fabricating chamber 722, which is caused by lowering the fabricating stage 724. Of the powder 720 transported from the supply chamber 721 to the fabricating chamber 722, the surplus powder 720 that does not fit into the fabricating chamber 722 and is not supplied in the fabricating chamber 722 falls into the surplus powder collecting chamber 729 and is recovered as a surplus powder 720a.

By allowing such a surplus powder 720a to be generated, while the flattening roller 712 transports the powder 720 to the downstream end of the fabricating chamber 722 in the “Y2” direction from the supply chamber 721 toward the fabricating chamber 722, the surplus powder 720 is always present on the downstream side in the movement direction of the flattening roller 712. In this manner, the presence of the surplus powder 720 on the downstream side in the movement direction of the flattening roller 712 provides a pressing effect against the powder 720 for forming the powder layer of predetermined thickness 731 due to the weight of the surplus powder 720 up to the downstream end in the movement direction of the flattening roller 712 in the fabricating chamber 722. As a result, this is advantageous to form the more uniform powder layer of predetermined thickness 731 having a high powder density.

Next, as illustrated in FIG. 13B and FIG. 13C, the flattening roller 712 is moved in the “Y2” direction from the supply chamber 721 toward the fabricating chamber 722 (forward route in the flattening direction). At this time, the flattening roller 712 is driven and rotated in the direction of an arrow in FIG. 13B and FIG. 13C (counterclockwise direction in FIG. 13). This rotational driving causes the bottom of the circumferential surface of the flattening roller 712 to perform surface movement in the same direction as the “Y2” direction. In this manner, the flattening roller 712 moves in the “Y2” direction while rotating in the counterclockwise direction in FIG. 13, so that the powder 720 present above the upper surface level of the supply chamber 721 can be smoothly transported in the “Y2” direction and supplied to the fabricating chamber 722. Then, the flattening roller 712 further moves in the “Y2” direction while rotating, and when passing above the fabricating chamber 722, the flattening roller 712 levels and flattens the surface of the powder 720 supplied to the fabricating chamber 722. As a result, a pre-powder layer 731a having a thickness greater than the target thickness “Δt” of the powder layer of predetermined thickness 731 to be finally formed is formed on the uppermost layered fabricated object 730.

Next, as illustrated in FIG. 13D, the supply stage 723 in the supply chamber 721 is lowered in the “Z2” direction (downward) by an amount of movement “z3”, and the fabricating stage 724 in the fabricating chamber 722 is lifted in the “Z1” direction by an amount of movement “z4”. As a result, the powder 720 of the upper layer of the pre-powder layer 731a formed on the fabricating stage 724 in the fabricating chamber 722 by the flattening process on the forward route described above is raised above the upper surface level of the fabricating chamber 722. The movement amount “z4” of the fabricating stage 724 at this time is set so that the distance between the upper surface of the lower powder layer of predetermined thickness 731 formed previously and the bottom of the flattening roller 712 becomes the target thickness “Δt1” of the powder layer of predetermined thickness 731.

Thereafter, as illustrated in FIG. 13E, the flattening roller 712 is moved in the Y1 direction from the fabricating chamber 722 toward the supply chamber 721 (return route in the flattening direction). At this time, the flattening roller 712 is driven and rotated in the direction of an arrow in FIG. 13D (clockwise direction in FIG. 13). This rotational driving causes the bottom side of the circumferential surface of the flattening roller 712 to perform surface movement in the same direction as the “Y1” direction. In this manner, the flattening roller 712 moves in the “Y1” direction while rotating in the clockwise direction in FIG. 13, so that the powder 20 present above the upper surface level of the fabricating chamber 722 is transported in the “Y1” direction, and the surface of the powder 720 in the fabricating chamber 722 is leveled and flattened. As a result, the powder layer of predetermined thickness 731 with the target thickness “Δt” is formed in the fabricating chamber 722.

Then, the flattening roller 712 moves further in the “Y1” direction while rotating and forms the pre-powder layer 731a when passing above the fabricating chamber 722. The unused powder 720 that was not used for forming the powder layer of predetermined thickness 731 is returned to the supply chamber 721.

After forming the powder layer of predetermined thickness 731, the flattening roller 712 passes above the supply chamber 721 and returns to the initial position (origin position) as illustrated in FIG. 13F. After that, the process is returned to the operation illustrated in FIG. 13A, and droplets of the fabricating liquid 710 are ejected from the head 752 to form the layered fabricated object 730 of a desired shape using the powder layer of predetermined thickness 731 thus formed.

Thereafter, as described above, the powder layer forming step in which the powder 720 is supplied and flattened to form the powder layer of predetermined thickness 731, and the fabricating liquid ejecting step in which the fabricating liquid 710 is ejected from the heads 752 are performed, thereby forming a new layered fabricated object 730 above the layered fabricated object 730 previously formed.

The layered fabricated object 730 is formed, for example, by mixing the fabricating liquid 710 ejected from the heads 752 with the powder 720, dissolving an adhesive included in the powder 720, and bonding the powder 720 by the adhesives dissolved and bonded together. The new layered fabricated object 730 and the layered fabricated object 730 below are integrated to form a part of the three-dimensional fabricated object.

By repeating the above-mentioned powder layer forming step and fabricating liquid ejecting step a required number of times, a three-dimensional-shape fabricated object (three-dimensional fabricated object) in which the layered fabricated objects 730 are stacked is completed.

Aspects of the present invention include, for example, the following.

### Aspect 1

A liquid ejection apparatus including:
a head tank that stores a liquid;
a liquid ejection head that ejects the liquid supplied from the head tank;
a liquid supply path between the head tank and the liquid ejection head; a liquid delivery device that delivers the liquid from the head tank to the liquid ejection head via the liquid supply path;
a filter disposed in the liquid supply path;
pressure measurement devices respectively disposed upstream and downstream of the filter; and
circuitry configure to control the liquid delivery device to perform a liquid discharge operation to discharge the liquid in the head tank based on a result calculated from a measurement values of the pressure measurement devices.

### Aspect 2

The liquid ejection apparatus described in the <Aspect 1>, in which the liquid discharge operation is an operation to discharge the liquid near the filter.

### Aspect 3

The liquid ejection apparatus described in the <Aspect 1> or <Aspect 2>, in which an amount of the liquid discharged by one time of the liquid discharge operation is 10 mL or less.

### Aspect 4

The liquid ejection apparatus described in any of the <Aspect 1> to <Aspect 3>, in which the result calculated from the measurement values of the pressure measurement devices is a fluid resistance value or a pressure loss value.

### Aspect 5

The liquid ejection apparatus described in the <Aspect 4>, in which the liquid discharge operation is performed when the pressure loss value exceeds 110% of its initial value.

### Aspect 6

The liquid ejection apparatus described in any of the <Aspect 1> to <Aspect 5>, further including at least one of a suction pump and a supply pump, the suction pump to suck the liquid in the head tank, and the supply pump to supply a fresh liquid to the head tank,
in which the liquid discharge operation includes one of the following operations:
a liquid suction operation performed by the suction pump;
both the liquid suction operation performed by the suction pump and a liquid supply operation performed by the supply pump; and
an operation of ejecting the liquid from the liquid ejection head.

### Aspect 7

The liquid ejection apparatus described in the <Aspect 4>, in which the circuitry is further configured to control the liquid delivery device to perform a recovery operation to recover the filter from clogging based on the fluid resistance value or the pressure loss value calculated after the liquid discharge operation.

### Aspect 8

The liquid ejection apparatus described in the <Aspect 7>, in which the circuitry is further configured to repeatedly calculate the fluid resistance value or the pressure loss value during the recovery operation.

### Aspect 9

The liquid ejection apparatus described in the <Aspect 7>, in which the circuitry is further configured to determine whether to perform the (n+1)ₜₕ recovery operation based on the fluid resistance value or the pressure loss value calculated after the nₜₕ recovery operation.

### Aspect 10

The liquid ejection apparatus described in the <Aspect 9>, in which the circuitry is further configured to perform the (n+1)ₜₕ recovery operation when recovery trend is observed in the fluid resistance value or the pressure loss value calculated after the nₜₕ recovery operation, and not to perform the (n+1)ₜₕ recovery operation when recovery trend is not observed in the fluid resistance value or the pressure loss value calculated after the nₜₕ recovery operation.

### Aspect 11

The liquid ejection apparatus described in the <Aspect 9>, in which the circuitry is further configured to terminate the recovery operation when the number of times the recovery operation is repeated reaches a predetermined number.

### Aspect 12

The liquid ejection apparatus described in any of the <Aspect 4> to <Aspect 11>, further including a cleaning device that cleans the liquid ejection head,
in which circuitry is further configured to calculate the fluid resistance value or the pressure loss value at the same time as regular maintenance performed by the cleaning device.

### Aspect 13

The liquid ejection apparatus described in any of the <Aspect 1> to <Aspect 12>, in which the filter is replaceable.

### Aspect 14

The liquid ejection apparatus described in any of the <Aspect 1> to <Aspect 13>, in which the liquid includes a coloring material, an organic solvent, and a resin, and solid contents of the coloring material and the resin account for 15% by mass or more of the liquid.

The liquid ejection apparatus described in any of the <Aspect 1> to <Aspect 14> can solve the above-mentioned various conventional problems and achieve the object of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A liquid ejection apparatus comprising:
a head tank that stores a liquid;
a liquid ejection head that ejects the liquid supplied from the head tank;
a liquid supply path between the head tank and the liquid ejection head;
a liquid delivery device that delivers the liquid from the head tank to the liquid ejection head via the liquid supply path;
a filter disposed in the liquid supply path;
pressure measurement devices respectively disposed upstream and downstream of the filter; and
circuitry configured to control the liquid delivery device to perform a liquid discharge operation to discharge the liquid in the head tank based on a result calculated from measurement values of the pressure measurement devices.

2. The liquid ejection apparatus according to claim 1, wherein the liquid discharge operation is an operation to discharge the liquid near the filter.

3. The liquid ejection apparatus according to claim 1, wherein an amount of the liquid discharged by one time of the liquid discharge operation is 10 mL or less.

4. The liquid ejection apparatus according to claim 1, wherein the result calculated from the measurement values of the pressure measurement devices is a fluid resistance value or a pressure loss value.

5. The liquid ejection apparatus according to claim 4, wherein the liquid discharge operation is performed when the pressure loss value exceeds 110% of its initial value.

6. The liquid ejection apparatus according to claim 1, further comprising:
at least one of a suction pump and a supply pump, the suction pump to suck the liquid in the head tank, and the supply pump to supply a fresh liquid to the head tank,
wherein the liquid discharge operation includes one of the following operations:
a liquid suction operation performed by the suction pump;
both the liquid suction operation performed by the suction pump and a liquid supply operation performed by the supply pump; and
an operation of ejecting the liquid from the liquid ejection head.

7. The liquid ejection apparatus according to claim 4, wherein the circuitry is further configured to control the liquid delivery device to perform a recovery operation to recover the filter from clogging based on the fluid resistance value or the pressure loss value calculated after the liquid discharge operation.

8. The liquid ejection apparatus according to claim 7, wherein the circuitry is further configured to repeatedly calculate the fluid resistance value or the pressure loss value during the recovery operation.

9. The liquid ejection apparatus according to claim 7, wherein the circuitry is further configured to determine whether to perform the (n+1)ₜₕ recovery operation based on the fluid resistance value or the pressure loss value calculated after the nₜₕ recovery operation.

10. The liquid ejection apparatus according to claim 9, wherein the circuitry is further configured to perform the (n+1)ₜₕ recovery operation when recovery trend is observed in the fluid resistance value or the pressure loss value calculated after the nₜₕ recovery operation, and not to perform the (n+1)ₜₕ recovery operation when recovery trend is not observed in the fluid resistance value or the pressure loss value calculated after the nₜₕ recovery operation.

11. The liquid ejection apparatus according to claim 9, wherein the circuitry is further configured to terminate the recovery operation when the number of times the recovery operation is repeated reaches a predetermined number.

12. The liquid ejection apparatus according to claim 4, further comprising:
a cleaning device that cleans the liquid ejection head,
wherein the circuitry is further configured to calculate the fluid resistance value or the pressure loss value at the same time as regular maintenance performed by the cleaning device.

13. The liquid ejection apparatus according to claim 1, wherein the filter is replaceable.

14. The liquid ejection apparatus according to claim 1, wherein the liquid includes a coloring material, an organic solvent, and a resin, and solid contents of the coloring material and the resin account for 15% by mass or more of the liquid.
